(19) United States
(12) Patent Application Publication
(10) Pub. No.: US 2025/0258678 A1
(43) Pub. Date: Aug. 14, 2025

(54) Flexible Runtime Execution and Communication Scheduler for Reconfigurable Processors

(71) Applicant: SambaNova Systems, Inc., Palo Alto, CA (US)

(72) Inventors: Joshua Earle POLZIN, Palo Alto, CA (US); Arnav GOEL, San Jose, CA (US); Qi ZHENG, Fremont, CA (US); Conrad Alexander TURLIK, Palo Alto, CA (US); Arjun SABNIS, San Francisco, CA (US); Jiayu BAI, Palo Alto, CA (US); Neal SANGHVI, Palo Alto, CA (US); Letao CHEN, Palo Alto, CA (US)

(73) Assignee: SambaNova Systems, Inc., Palo Alto, CA (US)

(21) Appl. No.: 18/441,161

(22) Filed: Feb. 14, 2024

(51) Int. Cl. G06F 9/4401; G06F 9/445; G06F 15/80

(52) U.S. Cl. CPC G06F 9/4405; G06F 9/44505; G06F 15/80

(57) ABSTRACT

A system including a reconfigurable processor, a runtime execution engine, a graph scheduler, and a communication scheduler is presented. The graph scheduler and the communication scheduler receive a dataflow graph and static schedules of graph and communication operations from a compiler. The graph scheduler and the communication scheduler generate new schedules of graph and communication operations based on user-defined schedules of graph and communication operations and the static schedules of graph and communication operations. The runtime execution engine uses the dataflow graph and the new schedules of graph and communication operations to configure an array of reconfigurable units in the reconfigurable processor for execution of the dataflow graph. The present technology also relates to a method of operating such a system, and to a non-transitory computer-readable storage medium including instructions that, when executed by a processing unit, cause the processing unit to operate such a system.

### RELATED APPLICATIONS AND DOCUMENTS

This application also is related to the following papers and commonly owned applications:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language And Compiler For Application Accelerators,” Proceedings Of The 39th ACM SIGPLAN Conference On Programming Language Design And Embodiment (PLDI), Proceedings of the 43rd International Symposium on Computer Architecture, 2018;
U.S. Nonprovisional patent application Ser. No. 16/239,252, now U.S. Pat. No. 10,698,853 B1, filed Jan. 3, 2019, entitled “VIRTUALIZATION OF A RECONFIGURABLE DATA PROCESSOR;”
U.S. Nonprovisional patent application Ser. No. 16/862,445, now U.S. Pat. No. 11,188,497 B2, filed Nov. 21, 2018, entitled “CONFIGURATION UNLOAD OF A RECONFIGURABLE DATA PROCESSOR;”
U.S. Nonprovisional patent application Ser. No. 16/197,826, now U.S. Pat. No. 10,831,507 B2, filed Nov. 21, 2018, entitled “CONFIGURATION LOAD OF A RECONFIGURABLE DATA PROCESSOR;”
U.S. Nonprovisional patent application Ser. No. 16/198,086, now U.S. Pat. No. 11,188,497 B2, filed Nov. 21, 2018, entitled “CONFIGURATION UNLOAD OF A RECONFIGURABLE DATA PROCESSOR;”
U.S. Nonprovisional patent application Ser. No. 17/093,543, filed Nov. 9, 2020, entitled “EFFICIENT CONFIGURATION OF A RECONFIGURABLE DATA PROCESSOR;”
U.S. Nonprovisional patent application Ser. No. 16/260,548, now U.S. Pat. No. 10,768,899 B2, filed Jan. 29, 2019, entitled “MATRIX NORMAL/TRANSPOSE READ AND A RECONFIGURABLE DATA PROCESSOR INCLUDING SAME;”
U.S. Nonprovisional patent application Ser. No. 16/536,192, now U.S. Pat. No. 11,080,227 B2, filed Aug. 8, 2019, entitled “COMPILER FLOW LOGIC FOR RECONFIGURABLE ARCHITECTURES;”
U.S. Nonprovisional patent application Ser. No. 17/326,128, filed May 20, 2021, entitled “COMPILER FLOW LOGIC FOR RECONFIGURABLE ARCHITECTURES;”
U.S. Nonprovisional patent application Ser. No. 16/407,675, now U.S. Pat. No. 11,386,038 B2, filed May 9, 2019, entitled “CONTROL FLOW BARRIER AND RECONFIGURABLE DATA PROCESSOR;”
U.S. Nonprovisional patent application Ser. No. 16/504,627, now U.S. Pat. No. 11,055,141 B2, filed Jul. 8, 2019, entitled “QUIESCE RECONFIGURABLE DATA PROCESSOR;”
U.S. Nonprovisional patent application Ser. No. 17/322,697, filed May 17, 2021, entitled “QUIESCE RECONFIGURABLE DATA PROCESSOR;”
U.S. Nonprovisional patent application Ser. No. 16/572,516, filed Sep. 16, 2019, entitled “EFFICIENT EXECUTION OF OPERATION UNIT GRAPHS ON RECONFIGURABLE ARCHITECTURES BASED ON USER SPECIFICATION;”
U.S. Nonprovisional patent application Ser. No. 16/744,077, filed Jan. 15, 2020, entitled “COMPUTATIONALLY EFFICIENT SOFTMAX LOSS GRADIENT BACKPROPAGATION;”
U.S. Nonprovisional patent application Ser. No. 16/590,058, now U.S. Pat. No. 11,327,713 B2, filed Oct. 1, 2019, entitled “COMPUTATION UNITS FOR FUNCTIONS BASED ON LOOKUP TABLES;”
U.S. Nonprovisional patent application Ser. No. 16/695,138, now U.S. Pat. No. 11,328,038 B2, filed Nov. 25, 2019, entitled “COMPUTATIONAL UNITS FOR BATCH NORMALIZATION;”
U.S. Nonprovisional patent application Ser. No. 16/688,069, filed Nov. 19, 2019, now U.S. Pat. No. 11,327,717 B2, entitled “LOOK-UP TABLE WITH INPUT OFFSETTING;”
U.S. Nonprovisional patent application Ser. No. 16/718,094, filed Dec. 17, 2019, now U.S. Pat. No. 11,150,872 B2, entitled “COMPUTATIONAL UNITS FOR ELEMENT APPROXIMATION;”
U.S. Nonprovisional patent application Ser. No. 16/560,057, now U.S. Pat. No. 11,327,923 B2, filed Sep. 4, 2019, entitled “SIGMOID FUNCTION IN HARDWARE AND A RECONFIGURABLE DATA PROCESSOR INCLUDING SAME;”
U.S. Nonprovisional patent application Ser. No. 16/572,527, now U.S. Pat. No. 11,410,027 B2, filed Sep. 16, 2019, entitled “Performance Estimation-Based Resource Allocation for Reconfigurable Architectures;”
U.S. Nonprovisional patent application Ser. No. 15/930,381, now U.S. Pat. No. 11,250,105 B2, filed May 12, 2020, entitled “COMPUTATIONALLY EFFICIENT GENERAL MATRIX-MATRIX MULTIPLICATION (GEMM);”
U.S. Nonprovisional patent application Ser. No. 17/337,080, now U.S. Pat. No. 11,328,209 B1, filed Jun. 2, 2021, entitled “MEMORY EFFICIENT DROPOUT;”
U.S. Nonprovisional patent application Ser. No. 17/337,126, now U.S. Pat. No. 11,256,987 B1, filed Jun. 2, 2021, entitled “MEMORY EFFICIENT DROPOUT, WITH REORDERING OF DROPOUT MASK ELEMENTS;”
U.S. Nonprovisional patent application Ser. No. 16/890,841, filed Jun. 2, 2020, entitled “ANTI-CONGESTION FLOW CONTROL FOR RECONFIGURABLE PROCESSORS;”
U.S. Nonprovisional patent application Ser. No. 17/023,015, now U.S. Pat. No. 11,237,971 B1, filed Sep. 16, 2020, entitled “COMPILE TIME LOGIC FOR DETECTING STREAMING COMPATIBLE AND BROADCAST COMPATIBLE DATA ACCESS PATTERNS;”
U.S. Nonprovisional patent application Ser. No. 17/031,679, filed Sep. 24, 2020, entitled “SYSTEMS AND METHODS FOR MEMORY LAYOUT DETERMINATION AND CONFLICT RESOLUTION;”
U.S. Nonprovisional patent application Ser. No. 17/175,289, now U.S. Pat. No. 11,126,574 B1, filed Feb. 12, 2021, entitled “INSTRUMENTATION PROFILING FOR RECONFIGURABLE PROCESSORS;”
U.S. Nonprovisional patent application Ser. No. 17/371,049, filed Jul. 8, 2021, entitled “SYSTEMS AND METHODS FOR EDITING TOPOLOGY OF A RECONFIGURABLE DATA PROCESSOR;”
U.S. Nonprovisional patent application Ser. No. 16/922,975, filed Jul. 7, 2020, entitled “RUNTIME VIRTUALIZATION OF RECONFIGURABLE DATA FLOW RESOURCES;”
U.S. Nonprovisional patent application Ser. No. 16/996,666, filed Aug. 18, 2020, entitled “RUNTIME PATCHING OF CONFIGURATION FILES;”
U.S. Nonprovisional patent application Ser. No. 17/214,768, now U.S. Pat. No. 11,200,096 B1, filed Mar. 26, 2021, entitled “RESOURCE ALLOCATION FOR RECONFIGURABLE PROCESSORS;”
U.S. Nonprovisional patent application Ser. No. 17/127,818, now U.S. Pat. No. 11,182,264 B1, filed Dec. 18, 2020, entitled “INTRA-NODE BUFFER-BASED STREAMING FOR RECONFIGURABLE PROCESSOR-AS-A-SERVICE (RPAAS);”
U.S. Nonprovisional patent application Ser. No. 17/127,929, now U.S. Pat. No. 11,182,221 B1, filed Dec. 18, 2020, entitled “INTER-NODE BUFFER-BASED STREAMING FOR RECONFIGURABLE PROCESSOR-AS-A-SERVICE (RPAAS);”
U.S. Nonprovisional patent application Ser. No. 17/185,264, filed Feb. 25, 2021, entitled “TIME-MULTIPLEXED USE OF RECONFIGURABLE HARDWARE;”
U.S. Nonprovisional patent application Ser. No. 17/216,647, now U.S. Pat. No. 11,204,889 B1, filed Mar. 29, 2021, entitled “TENSOR PARTITIONING AND PARTITION ACCESS ORDER;”
U.S. Nonprovisional patent application Ser. No. 17/216,650, now U.S. Pat. No. 11,366,783 B1, filed Mar. 29, 2021, entitled “MULTI-HEADED MULTI-BUFFER FOR BUFFERING DATA FOR PROCESSING;”
U.S. Nonprovisional patent application Ser. No. 17/216,657, now U.S. Pat. No. 11,263,170 B1, filed Mar. 29, 2021, entitled “LOSSLESS TILING IN CONVOLUTION NETWORKS-PADDING BEFORE TILING, LOCATION-BASED TILING, AND ZEROING-OUT;”
U.S. Nonprovisional patent application Ser. No. 17/384,515, filed Jul. 23, 2021, entitled “LOSSLESS TILING IN CONVOLUTION NETWORKS-MATERIALIZATION OF TENSORS;”
U.S. Nonprovisional patent application Ser. No. 17/216,651, now U.S. Pat. No. 11,195,080 B1, filed Mar. 29, 2021, entitled “LOSSLESS TILING IN CONVOLUTION NETWORKS-TILING CONFIGURATION;”
U.S. Nonprovisional patent application Ser. No. 17/216,652, now U.S. Pat. No. 11,227,207 B1, filed Mar. 29, 2021, entitled “LOSSLESS TILING IN CONVOLUTION NETWORKS-SECTION BOUNDARIES;”
U.S. Nonprovisional patent application Ser. No. 17/216,654, now U.S. Pat. No. 11,250,061 B1, filed Mar. 29, 2021, entitled “LOSSLESS TILING IN CONVOLUTION NETWORKS-READ-MODIFY-WRITE IN BACKWARD PASS;”
U.S. Nonprovisional patent application Ser. No. 17/216,655, now U.S. Pat. No. 11,232,360 B1, filed Mar. 29, 2021, entitled “LOSSLESS TILING IN CONVOLUTION NETWORKS-WEIGHT GRADIENT CALCULATION;”
U.S. Nonprovisional patent application Ser. No. 17/364,110, filed Jun. 30, 2021, entitled “LOSSLESS TILING IN CONVOLUTION NETWORKS-TILING CONFIGURATION FOR A SEQUENCE OF SECTIONS OF A GRAPH;”
U.S. Nonprovisional patent application Ser. No. 17/364,129, filed Jun. 30, 2021, entitled “LOSSLESS TILING IN CONVOLUTION NETWORKS-TILING CONFIGURATION BETWEEN TWO SECTIONS;”
“U.S. Nonprovisional patent application Ser. No. 17/364,141, filed Jun. 30, 2021, entitled “ ” LOSSLESS TILING IN CONVOLUTION NETWORKS-PADDING AND RE-TILLING AT SECTION BOUNDARIES;”
U.S. Nonprovisional patent application Ser. No. 17/384,507, filed Jul. 23, 2021, entitled “LOSSLESS TILING IN CONVOLUTION NETWORKS-BACKWARD PASS;”
U.S. Provisional Patent Application No. 63/107,413, filed Oct. 29, 2020, entitled “SCANNABLE LATCH ARRAY FOR STRUCTURAL TEST AND SILICON DEBUG VIA SCANDUMP;”
U.S. Provisional Patent Application No. 63/165,073, filed Mar. 23, 2021, entitled “FLOATING POINT MULTIPLY-ADD, ACCUMULATE UNIT WITH CARRY-SAVE ACCUMULATOR IN BF16 AND FLP32 FORMAT;”
U.S. Provisional Patent Application No. 63/166,221, filed Mar. 25, 2021, entitled “LEADING ZERO AND LEADING ONE DETECTOR PREDICTOR SUITABLE FOR CARRY-SAVE FORMAT;”
U.S. Provisional Patent Application No. 63/174,460, filed Apr. 13, 2021, entitled “EXCEPTION PROCESSING IN CARRY-SAVE ACCUMULATION UNIT FOR MACHINE LEARNING;”
U.S. Nonprovisional patent application Ser. No. 17/397,241, now U.S. Pat. No. 11,429,349 B1, filed Aug. 9, 2021, entitled “FLOATING POINT MULTIPLY-ADD, ACCUMULATE UNIT WITH CARRY-SAVE ACCUMULATOR;”
U.S. Nonprovisional patent application Ser. No. 17/216,509, now U.S. Pat. No. 11,191,182 B1, filed Mar. 29, 2021, entitled “UNIVERSAL RAIL KIT;”
U.S. Nonprovisional patent application Ser. No. 17/379,921, now U.S. Pat. No. 11,392,740 B2, filed Jul. 19, 2021, entitled “DATAFLOW FUNCTION OFFLOAD TO RECONFIGURABLE PROCESSORS;”
U.S. Nonprovisional patent application Ser. No. 17/379,924, now U.S. Pat. No. 11,237,880 B1, filed Jul. 19, 2021, entitled “DATAFLOW ALL-REDUCE FOR RECONFIGURABLE PROCESSOR SYSTEMS;”
U.S. Nonprovisional patent application Ser. No. 17/378,342, now U.S. Pat. No. 11,556,494 B1, filed Jul. 16, 2021, entitled “DEFECT REPAIR FOR A RECONFIGURABLE DATA PROCESSOR;”
U.S. Nonprovisional patent application Ser. No. 17/378,391, now U.S. Pat. No. 11,327,771 B1, filed Jul. 16, 2021, entitled “DEFECT REPAIR CIRCUITS FOR A RECONFIGURABLE DATA PROCESSOR;”
U.S. Nonprovisional patent application Ser. No. 17/378,399, now U.S. Pat. No. 11,409,540 B1, filed Jul. 16, 2021, entitled “ROUTING CIRCUITS FOR DEFECT REPAIR FOR A RECONFIGURABLE DATA PROCESSOR;”
U.S. Provisional Patent Application No. 63/220,266, filed Jul. 9, 2021, entitled “LOGIC BIST AND FUNCTIONAL TEST FOR A CGRA;”
U.S. Provisional Patent Application No. 63/195,664, filed Jun. 1, 2021, entitled “VARIATION-TOLERANT VARIABLE-LENGTH CLOCK-STRETCHER MODULE WITH IN-SITU END-OF-CHAIN DETECTION MECHANISM;”
U.S. Nonprovisional patent application Ser. No. 17/338,620, now U.S. Pat. No. 11,323,124 B1, filed Jun. 3, 2021, entitled “VARIABLE-LENGTH CLOCK STRETCHER WITH CORRECTION FOR GLITCHES DUE TO FINITE DLL BANDWIDTH;”
U.S. Nonprovisional patent application Ser. No. 17/338,625, now U.S. Pat. No. 11,239,846 B1, filed Jun. 3, 2021, entitled “VARIABLE-LENGTH CLOCK STRETCHER WITH CORRECTION FOR GLITCHES DUE TO PHASE DETECTOR OFFSET;”
U.S. Nonprovisional patent application Ser. No. 17/338,626, now U.S. Pat. No. 11,290,113 B1, filed Jun. 3, 2021, entitled “VARIABLE-LENGTH CLOCK STRETCHER WITH CORRECTION FOR DIGITAL DLL GLITCHES;”
U.S. Nonprovisional patent application Ser. No. 17/338,629, now U.S. Pat. No. 11,290,114 B1, filed Jun. 3, 2021, entitled “VARIABLE-LENGTH CLOCK STRETCHER WITH PASSIVE MODE JITTER REDUCTION;”
U.S. Nonprovisional patent application Ser. No. 17/405,913, now U.S. Pat. No. 11,334,109 B1, filed Aug. 18, 2021, entitled “VARIABLE-LENGTH CLOCK STRETCHER WITH COMBINER TIMING LOGIC;”
U.S. Provisional Patent Application No. 63/230,782, filed Aug. 8, 2021, entitled “LOW-LATENCY MASTER-SLAVE CLOCKED STORAGE ELEMENT;”
U.S. Provisional Patent Application No. 63/236,218, filed Aug. 23, 2021, entitled “SWITCH FOR A RECONFIGURABLE DATAFLOW PROCESSOR;”
U.S. Provisional Patent Application No. 63/236,214, filed Aug. 23, 2021, entitled “SPARSE MATRIX MULTIPLIER;”
U.S. Provisional Patent Application No. 63/389,767, filed Jul. 15, 2022. entitled “PEER-TO-PEER COMMUNICATION BETWEEN RECONFIGURABLE DATAFLOW UNITS;”
U.S. Provisional Patent Application No. 63/405,240, filed Sep. 9, 2022, entitled “PEER-TO-PEER ROUTE THROUGH IN A RECONFIGURABLE COMPUTING SYSTEM.”

All of the related application(s) and documents listed above are hereby incorporated by reference herein for all purposes.

### FIELD OF THE TECHNOLOGY DISCLOSED

The present technology relates to a system including a reconfigurable processor, a runtime execution engine, a graph scheduler, and a communication scheduler, and more particularly to a system in which the graph scheduler and the communication scheduler receive a dataflow graph and static schedules from a compiler and use the static schedules and user-defined schedules to generate new schedules, and in which the runtime execution engine uses the dataflow graph and the new schedules to configure an array of reconfigurable units in the reconfigurable processor for execution of the dataflow graph.

Furthermore, the present technology relates to a method of operating a system with a reconfigurable processor, a runtime execution engine, a graph scheduler, and a communication scheduler, and to a non-transitory computer-readable storage medium including instructions that, when executed by a processing unit, cause the processing unit to operate a system comprising a reconfigurable processor, a runtime execution engine, a graph scheduler, and a communication scheduler.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

With the rapid expansion of applications that can be characterized by dataflow processing, such as natural-language processing and recommendation engines, the performance and efficiency challenges of traditional, instruction set architectures have become apparent. First, the sizable, generation-to-generation performance gains for multicore processors have tapered off. As a result, developers can no longer depend on traditional performance improvements to power more complex and sophisticated applications. This holds true for both CPU fat-core and GPU thin-core architectures.

A new approach is required to extract more useful work from current semiconductor technologies. Amplifying the gap between required and available computing is the explosion in the use of deep learning. According to a study by OpenAI, during the period between 2012 and 2020, the compute power used for notable artificial intelligence achievements has doubled every 3.4 months.

While the performance challenges are acute for machine learning, other workloads such as analytics, scientific applications and even SQL data processing all could benefit from dataflow processing. New approaches should be flexible enough to support broader workloads and facilitate the convergence of machine learning and high-performance computing or machine learning and business applications.

It is common for GPUs to be used for training and CPUs to be used for inference in machine learning systems based on their different characteristics. Many real-life systems demonstrate continual and sometimes unpredictable change, which means predictive accuracy of models declines without frequent updates.

Alternatively, reconfigurable processors, including FPGAs, can be configured to implement a variety of functions more efficiently or faster than might be achieved using a general-purpose processor executing a computer program.

Recently, so-called coarse-grained reconfigurable architectures (CGRAs) are being developed in which the configurable units in the array are more complex than used in typical, more fine-grained FPGAs, and may enable faster or more efficient execution of various classes of functions. For example, CGRAs have been proposed that can enable implementation of low-latency and energy-efficient accelerators for machine learning and artificial intelligence workloads.

Such reconfigurable processors, and especially CGRAs, are usually implemented as dataflow architectures and often include specialized hardware elements such as computing resources and device memory that operate in conjunction with one or more software elements such as a CPU and attached host memory in implementing user applications.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 is a diagram of an illustrative data processing system including a coarse-grained reconfigurable (CGR) processor, CGR processor memory, and a host processor.

FIG. 2 is a diagram of an illustrative computer, including an input device, a processor, a storage device, and an output device.

FIG. 3 is a diagram of an illustrative reconfigurable processor including a top-level network (TLN) and two CGR arrays.

FIG. 4 is a diagram of an illustrative CGR array including CGR units and an array-level network (ALN).

FIG. 5 illustrates an example of a pattern memory unit (PMU) and a pattern compute unit (PCU), which may be combined in a fused-control memory unit (FCMU).

FIG. 6 is a diagram of an illustrative system with a compiler suitable for generating a dataflow graph and static schedules, a graph scheduler, a communication scheduler, a runtime execution engine, and a reconfigurable processor.

FIG. 7 is a diagram of an illustrative graph scheduler that receives an application as a dataflow graph with a static schedule of graph operations and a user-defined schedule of the graph operations and that generates a new schedule of the graph operations.

FIG. 8 is a diagram of an illustrative communication scheduler that receives an application as a dataflow graph with a static schedule of communication operations and a user-defined schedule of the communication operations and that generates a new schedule of the communication operations.

FIG. 9A is a diagram of an illustrative static schedule of graph operations.

FIG. 9B is a diagram of an illustrative new schedule of graph operations based on a user-defined schedule of the graph operations and the static schedule of the graph operations of FIG. 9A.

FIG. 10A is a diagram of an illustrative static schedule of communication operations.

FIG. 10B is a diagram of an illustrative new schedule of communication operations based on a user-defined schedule of the communication operations and the static schedule of the communication operations of FIG. 10A.

FIG. 11A is a diagram of an illustrative static schedule of communication operations that can be pipelined and parallelized.

FIG. 11B is a diagram of an illustrative modified pipelined and parallelized schedule of communication operations based on a user-defined schedule of the communication operations and the static schedule of the communication operations of FIG. 11A.

FIG. 12 is a flowchart showing illustrative operations that a system including a runtime execution engine, a graph scheduler, a communication scheduler, and a reconfigurable processor with an array of reconfigurable units performs for implementing and executing a dataflow graph.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Traditional compilers translate human-readable computer source code into machine code that can be executed on a Von Neumann computer architecture. In this architecture, a processor serially executes instructions in one or more threads of software code. The architecture is static and the compiler does not determine how execution of the instructions is pipelined, or which processor or memory takes care of which thread. Thread execution is asynchronous, and safe exchange of data between parallel threads is not supported.

Applications for machine learning (ML) and artificial intelligence (AI) may require massively parallel computations, where many parallel and interdependent threads (metapipelines) exchange data. Therefore, such applications are ill-suited for execution on Von Neumann computers. They require architectures that are adapted for parallel processing, such as reconfigurable architectures or graphic processing units (GPUs).

Coarse-grained reconfigurable architectures (CGRAs) are an extremely attractive platform when performance, power, or energy efficiency are paramount. A CGRA is usually a composition of coarse-grained reconfigurable compute and memory elements that are interconnected together in a certain topology using a reconfigurable interconnect fabric. It is referred to as coarse-grained reconfigurable because the reconfigurable components in the architecture operate at a coarser granularity such as instructions, words, and vectors of words, as opposed to fine-grained, bit-level granularity commonly found in architectures such as FPGAs. The programmable data and control paths in CGRAs make them a natural fit to exploit nested parallelism in applications, by connecting the reconfigurable compute and memory components into customized, deeply nested, and hierarchical pipelines. A CGRA often operates in conjunction with one or more software elements such as a host processor and attached host memory.

The ascent of ML, AI, and massively parallel architectures places new requirements on compilers. Such compilers are required to pipeline computation graphs, or dataflow graphs, decide which operations of a dataflow graph are assigned to which portions of the reconfigurable processor, how data is routed between various compute units and memory units, and how synchronization is controlled, particularly when a dataflow graph includes one or more nested loops, whose execution time varies dependent on the data being processed.

In this context, it is particularly important for the compiler to extract the dependencies between graph operations and communications operations of a dataflow graph and provide a schedule of the graph operations and the communication operations in view of an implementation of the dataflow graph on a given reconfigurable processor. Such an implementation targets a low utilization rate of the reconfigurable processor's hardware resources and a short total execution time of the dataflow graph on the reconfigurable processor.

However, in some scenarios, a user may want to provide a different schedule of the graph operations and the communication operations. As an example, a user may simply want to change the order of execution of the graph operations and the communication operations to test a different implementation of the dataflow graph. As another example, a user may want to chain some graph operations and communication operations together to improve total execution time of the dataflow graph on the reconfigurable processor. As yet another example, a user may want to eliminate false dependencies between graph operations (e.g., dependencies that a compiler has detected, but that the user knows are irrelevant for the execution of the dataflow graph) and parallelize graph operations.

Therefore, it is desirable to provide a new system with a reconfigurable processor, a runtime execution engine, a graph scheduler, and a communication scheduler for implementing and executing a dataflow graph on the reconfigurable processor. The graph scheduler and the communication scheduler should assist with making dynamic changes to a static schedule of graph operations and a static schedule of communication operations. Illustratively, a compiler may generate such static schedules based on the topology of the dataflow graph.

The new system should be able to accept user-defined schedules of graph operations and communication operations and quickly and reliably generate new schedules of graph operations and communication operations based on the user-defined schedules of the graph operations and the communication operations.

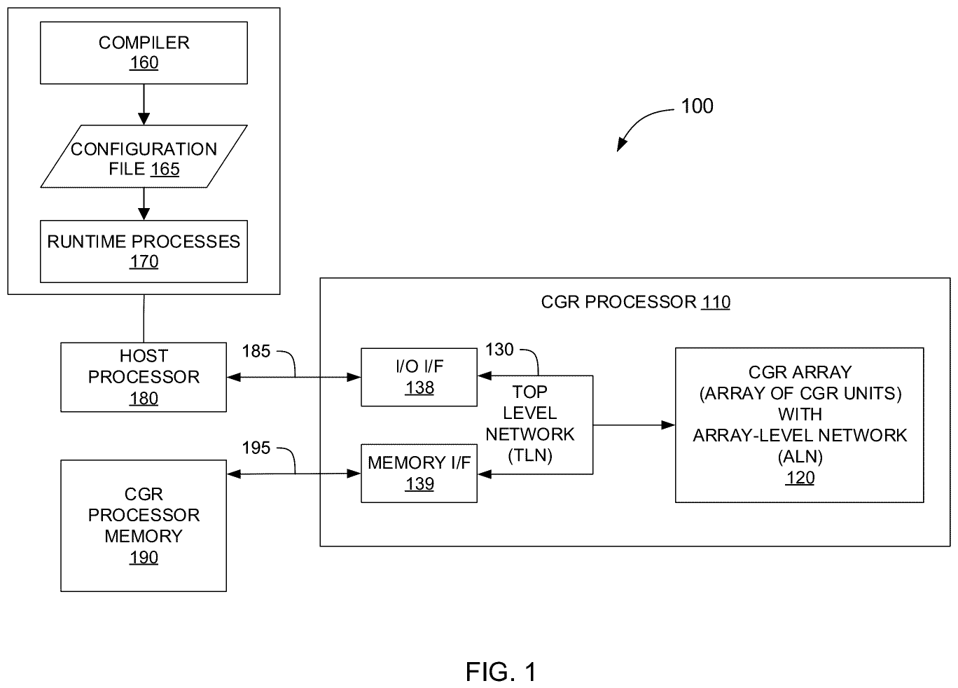

FIG. 1 illustrates an example data processing system 100 including a host processor 180, a reconfigurable processor such as a coarse-grained reconfigurable (CGR) processor 110, and an attached CGR processor memory 190. As shown, CGR processor 110 has a coarse-grained reconfigurable architecture (CGRA) and includes an array of reconfigurable units, or more particularly, an array of CGR units 120 such as a CGR array. CGR processor 110 may include an input-output (I/O) interface 138 and a memory interface 139. Array of CGR units 120 may be coupled with (I/O) interface 138 and memory interface 139 via databus 130 which may be part of a top-level network (TLN). Host processor 180 communicates with I/O interface 138 via system databus 185, which may be a local bus as described hereinafter, and memory interface 139 communicates with attached CGR processor memory 190 via memory bus 195.

Array of CGR units 120 may further include compute units and memory units that are interconnected with an array-level network (ALN) to provide the circuitry for execution of a computation graph or a dataflow graph that may have been derived from a high-level program with user algorithms and functions. A high-level program is source code written in programming languages like Spatial, Python, C++, and C. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

If desired, the high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may perform serial and/or parallel processing.

The architecture, configurability, and data flow capabilities of CGR array 120 enables increased compute power that supports both parallel and pipelined computation. CGR processor 110, which includes CGR arrays 120, can be programmed to simultaneously execute multiple independent and interdependent dataflow graphs. To enable simultaneous execution, the dataflow graphs may be distilled from a high-level program and translated to a configuration file for the CGR processor 110. In some implementations, execution of the dataflow graphs may involve using more than one CGR processor 110.

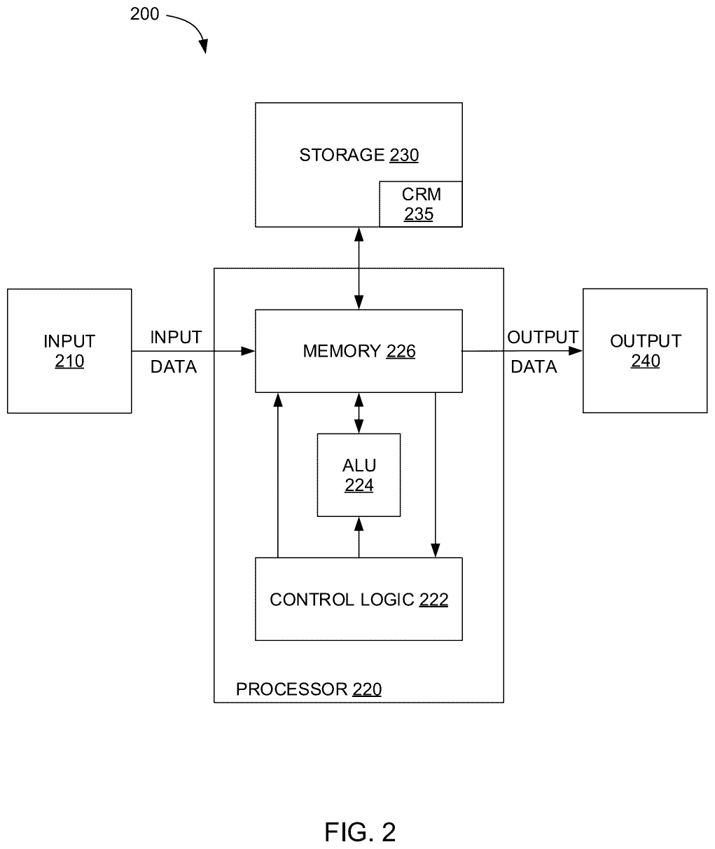

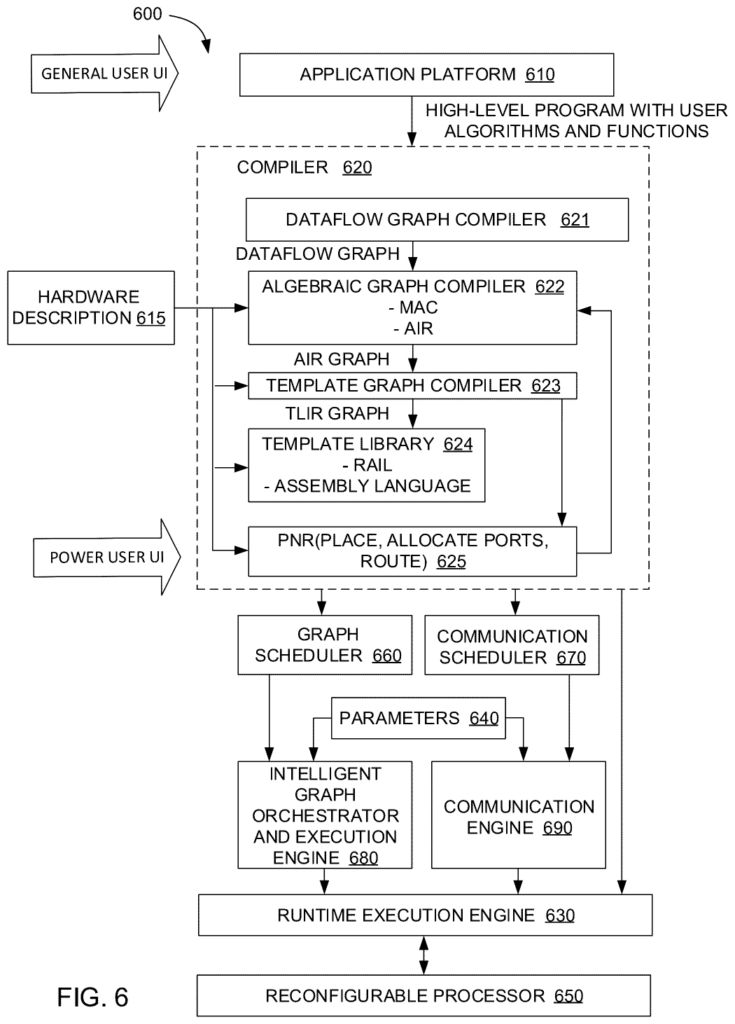

Host processor 180 may be, or include, a computer such as further described with reference to FIG. 2. Host processor 180 runs runtime processes 170, as further referenced herein. When the host processor 180 executes runtime processes 170, the host processor 180 is sometimes also referred to as runtime execution engine. In some implementations, host processor 180 may also be used to run computer programs, such as the compiler 160 further described herein with reference to FIG. 6. In some implementations, the compiler may run on a computer that is similar to the computer described with reference to FIG. 2, but separate from host processor 180.

The compiler may perform the translation of high-level programs to executable bit files. While traditional compilers sequentially map operations to processor instructions, typically without regard to pipeline utilization and duration (a task usually handled by the hardware), an array of CGR units 120 requires mapping operations to processor instructions in both space (for parallelism) and time (for synchronization of interdependent computation graphs or dataflow graphs). This requirement implies that a compiler for the CGR array 120 decides which operation of a computation graph or dataflow graph is assigned to which of the CGR units in the CGR array 120, and how both data and, related to the support of dataflow graphs, control information flows among CGR units in the CGR array 120, and to and from host processor 180 and attached CGR processor memory 190. Thus, the compiler for the CGR array 120 generates a static schedule of graph operations and a static schedule of communication operations for execution of the dataflow graph on the CGR array 120.

CGR processor 110 may accomplish computational tasks by executing a configuration file (e.g., a processor-executable format (PEF) file). For the purposes of this description, a configuration file corresponds to a dataflow graph, or a translation of a dataflow graph, and may further include initialization data including a static schedule of graph operations and a static schedule of communication operations.

A compiler compiles the high-level program to provide the configuration file 165. A runtime execution engine that executes runtime processes 170 may install the configuration file 165 in CGR processor 110. In some implementations described herein, a CGR array 120 is configured by programming one or more configuration stores with all or parts of the configuration file 165. Therefore, the configuration file is sometimes also referred to as a programming file.

A single configuration store may be at the level of the CGR processor 110 or the CGR array 120, or a CGR unit may include an individual configuration store. The configuration file 165 may include configuration data for the CGR array and CGR units in the CGR array, and link the computation graph to the CGR array. Execution of the configuration file by CGR processor 110 causes the CGR array(s) to implement the user algorithms and functions in the dataflow graph.

CGR processor 110 can be implemented on a single integrated circuit (IC) die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor 220, other implementations may have multiple processors. Input device 210 may comprise a mouse, a keyboard, a sensor, an input port (e.g., a universal serial bus (USB) port), and/or any other input device known in the art. Output device 240 may comprise a monitor, printer, and/or any other output device known in the art. Illustratively, part or all of input device 210 and output device 240 may be combined in a network interface, such as a Peripheral Component Interconnect Express (PCIe) interface suitable for communicating with CGR processor 110 of FIG. 1.

Input device 210 is coupled with processor 220, which is sometimes also referred to as host processor 220, to provide input data. If desired, memory 226 of processor 220 may store the input data. Processor 220 is coupled with output device 240. In some implementations, memory 226 may provide output data to output device 240.

Processor 220 further includes control logic 222 and arithmetic logic unit (ALU) 224. Control logic 222 may be operable to control memory 226 and ALU 224. If desired, control logic 222 may be operable to receive program and configuration data from memory 226. Illustratively, control logic 222 may control exchange of data between memory 226 and storage device 230. Memory 226 may comprise memory with fast access, such as static random-access memory (SRAM). Storage device 230 may comprise memory with slow access, such as dynamic random-access memory (DRAM), flash memory, magnetic disks, optical disks, and/or any other memory type known in the art. At least a part of the memory in storage device 230 includes a non-transitory computer-readable medium (CRM) 235, such as used for storing computer programs. The storage device 230 is sometimes also referred to as host memory.

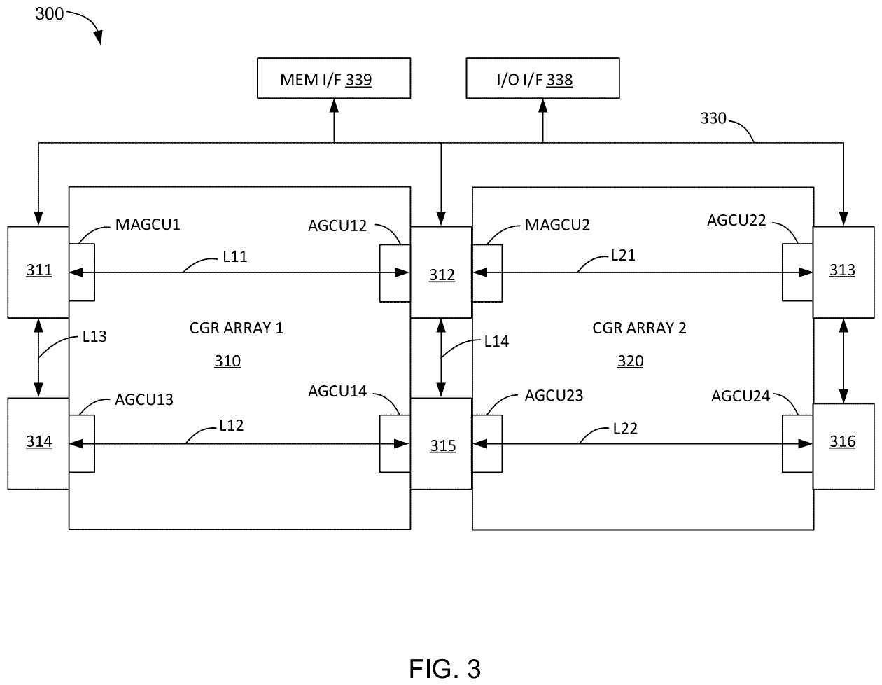

FIG. 3 illustrates example details of a CGR architecture 300 including a top-level network (TLN 330) and two CGR arrays (CGR array 310 and CGR array 320). A CGR array comprises an array of CGR units (e.g., pattern memory units (PMUs), pattern compute units (PCUs), fused-control memory units (FCMUs)) coupled via an array-level network (ALN), e.g., a bus system. The ALN may be coupled with the TLN 330 through several Address Generation and Coalescing Units (AGCUs), and consequently with input/output (I/O) interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN 330 and external devices, such as high-capacity memory, host processors, other CGR processors, FPGA devices, and so on, that may be coupled with the interfaces.

As shown in FIG. 3, each CGR array 310, 320 has four AGCUs (e.g., MAGCU1, AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN 330 may be constructed using top-level switches (e.g., switch 311, switch 312, switch 313, switch 314, switch 315, and switch 316). If desired, the top-level switches may be coupled with at least one other top-level switch. At least some top-level switches may be connected with other circuits on the TLN, including the AGCUs, and external I/O interface 338.

Illustratively, the TLN 330 includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

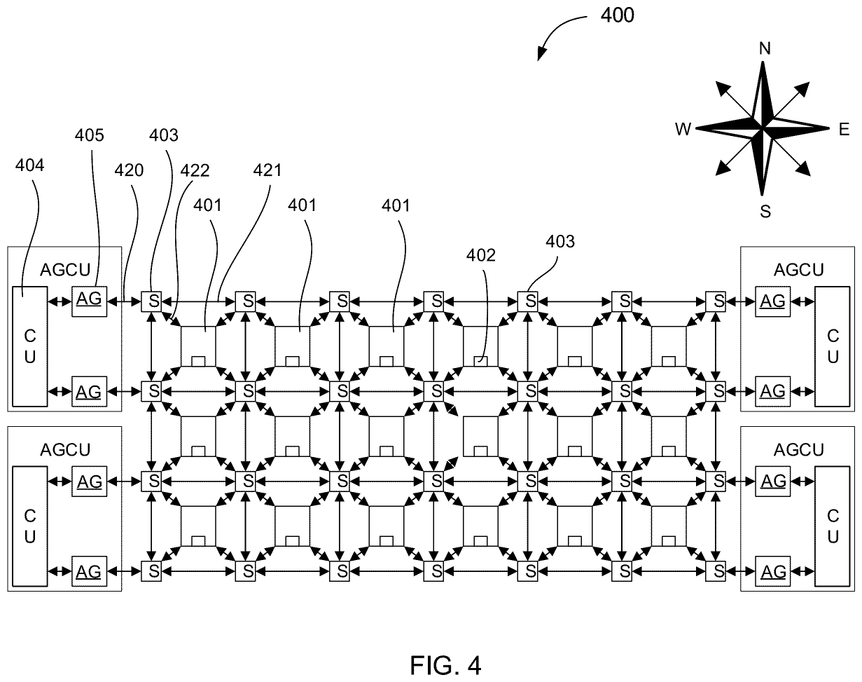

FIG. 4 shows an illustrative array of reconfigurable units, and, more particularly, an illustrative CGR array 400, including an array of CGR units in an ALN. CGR array 400 may include several types of CGR unit 401, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017 Jun. 24-28, 2017, Toronto, ON, Canada.

Illustratively, each CGR unit of the CGR units may include a configuration store 402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns.

The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units 401 that execute a high-level program with user algorithms and functions. Program load is the process of setting up the configuration stores 402 in the CGR array 400 based on the configuration data to allow the CGR units 401 to execute the high-level program. Program load may also require loading memory units and/or PMUs.

In some implementations, a runtime processor (e.g., the portions of host processor 180 of FIG. 1 that execute runtime processes 170, which is sometimes also referred to as “runtime execution engine”) may perform the program load.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., Northeast, Northwest, Southeast, Southwest, etc.) used to reach the destination unit.

A CGR unit 401 may have four ports (as drawn) to interface with switch units 403, or any other number of ports suitable for an ALN. Each port may be suitable for receiving and transmitting data, or a port may be suitable for only receiving or only transmitting data.

A switch unit 403, as shown in the example of FIG. 4, may have eight interfaces. The North, South, East and West interfaces of a switch unit may be used for links between switch units 403 using interconnects 421. The Northeast, Southeast, Northwest and Southwest interfaces of a switch unit 403 may each be used to make a link with an FCMU, PCU or PMU instance using one of the interconnects 422. Two switch units 403 in each CGR array quadrant have links to an AGCU using interconnects 420. The coalescing unit 404 of the AGCU arbitrates between the address generators 405 and processes memory requests. Each of the eight interfaces of a switch unit 403 can include a vector interface, a scalar interface, and a control interface to communicate with the vector network, the scalar network, and the control network. In other implementations, a switch unit 403 may have any number of interfaces.

During execution of a dataflow graph or subgraph in a CGR array 400 after configuration, data can be sent via one or more switch units 403 and one or more interconnects 421 between the switch units to the CGR units 401 using the vector bus and vector interface(s) of the one or more switch units 403 on the ALN. A CGR array may comprise at least a part of CGR array 400, and any number of other CGR arrays coupled with CGR array 400.

A data processing operation implemented by CGR array configuration may comprise multiple dataflow graphs or subgraphs specifying data processing operations that are distributed among and executed by corresponding CGR units (e.g., FCMUs, PMUs, PCUs, AGs, and CUs).

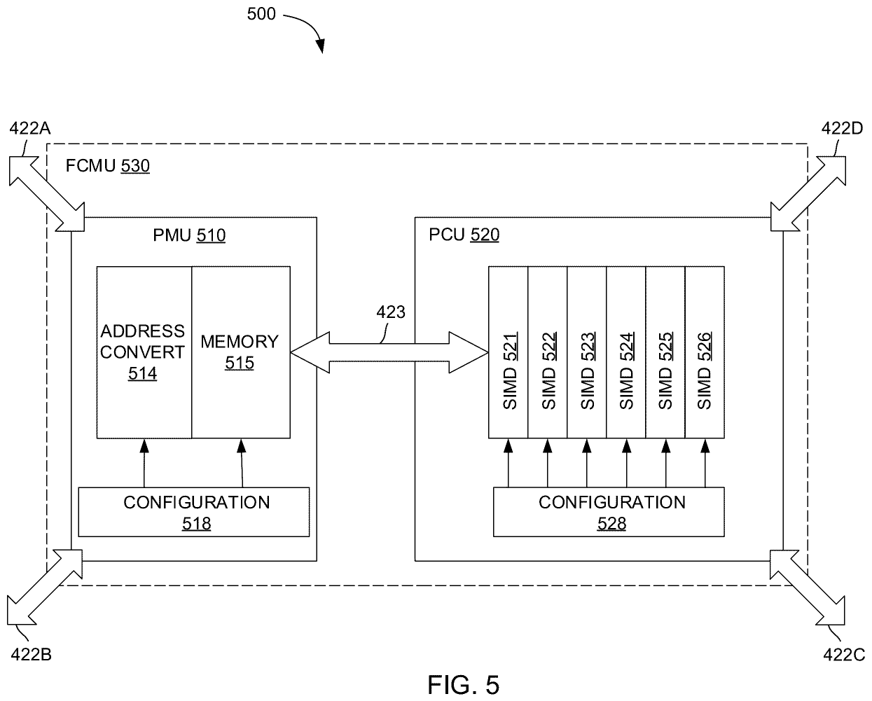

FIG. 5 illustrates an example 500 of a PMU 510 and a PCU 520, which may be combined in an FCMU 530. PMU 510 may be directly coupled to PCU 520, or optionally via one or more switches. The FCMU 530 may include multiple ALN links, such as ALN link 423 that connects PMU 510 with PCU 520, northwest ALN link 422A and southwest ALN link 422B, which may connect to PMU 510, and southeast ALN link 422C and northeast ALN link 422D, which may connect to PCU 520. The northwest ALN link 422A, southwest ALN link 422B, southeast ALN link 422C, and northeast ALN link 422D may connect to switches 403 as shown in FIG. 4. Each ALN link 422A-D, 423 may include one or more scalar links, one or more vector links, and one or more control links where an individual link may be unidirectional into FCMU 530, unidirectional out of FCMU 530 or bidirectional. FCMU 530 can include FIFOs to buffer data entering and/or leaving the FCMU 530 on the links.

PMU 510 may include an address converter 514, a scratchpad memory 515, and a configuration store 518. Configuration store 518 may be loaded, for example, from a program running on host processor 180 as shown in FIG. 1, and can configure address converter 514 to generate or convert address information for scratchpad memory 515 based on data received through one or more of the ALN links 422A-B, and/or 423. Data received through ALN links 422A-B, and/or 423 may be written into scratchpad memory 515 at addresses provided by address converter 514. Data read from scratchpad memory 515 at addresses provided by address converter 514 may be sent out on one or more of the ALN links 422A-B, and/or 423.

PCU 520 includes two or more processor stages, such as single-instruction multiple-data (SIMD) 521 through SIMD 526, and configuration store 528. The processor stages may include SIMDs, as drawn, or any other reconfigurable stages that can process data. PCU 520 may receive data through ALN links 422C-D, and/or 423, and process the data in the two or more processor stages or store the data in configuration store 528. PCU 520 may produce data in the two or more processor stages, and transmit the produced data through one or more of the ALN links 422C-D, and/or 423. If the two or more processor stages include SIMDs, then the SIMDs may have a number of lanes of processing equal to the number of lanes of data provided by a vector interconnect of ALN links 422C-D, and/or 423.

Each stage in PCU 520 may also hold one or more registers (not drawn) for short-term storage of parameters. Short-term storage, for example during one to several clock cycles or unit delays, allows for synchronization of data in the PCU pipeline.

FIG. 6 is a block diagram of an illustrative system 600 with a compiler 620 suitable for generating a dataflow graph and static schedules of graph operations and communication operations, graph and communication schedulers 660, 670, a runtime execution engine 630 (e.g., host processor 180 of FIG. 1 executing runtime processes 170), and a reconfigurable processor 650 having an array of reconfigurable units such as CGR processor 110 of FIG. 1 that has a CGR array 120.

As depicted, the compiler 620 includes several stages to convert a high-level program with statements that define user algorithms and functions, e.g., algebraic expressions and functions, to configuration data for the CGR units. A high-level program may include source code written in programming languages like C, C++, Java, JavaScript, Python, and/or Spatial, for example. In some implementations, the high-level program may include statements that invoke various PyTorch functions.

The compiler 620 may take its input from application platform 610, or any other source of high-level program statements suitable for parallel processing, which provides a user interface for general users. If desired, the compiler 620 may further receive hardware description 615, for example defining the physical units in a reconfigurable data processor or CGR processor. Application platform 610 may include libraries such as PyTorch, TensorFlow, ONNX, Caffe, and Keras to provide user-selected and configured algorithms.

Application platform 610 outputs a high-level program to compiler 620, which in turn outputs a configuration file with which the runtime execution engine 630 manages execution of the application on the reconfigurable processor 650.

Compiler 620 may include dataflow graph compiler 621, which may handle a dataflow graph, algebraic graph compiler 622, template graph compiler 623, template library 624, and placer and router PNR 625. In some implementations, template library 624 includes RDU abstract intermediate language (RAIL) and/or assembly language interfaces for power users.

Dataflow graph compiler 621 converts the high-level program with user algorithms and functions from application platform 610 to one or more dataflow graphs. The high-level program may be suitable for parallel processing, and therefore parts of the nodes of the dataflow graphs may be intrinsically parallel unless an edge in the graph indicates a dependency. Dataflow graph compiler 621 may provide code optimization steps like false data dependency elimination, dead-code elimination, and constant folding. The dataflow graphs encode the data and control dependencies of the high-level program.

Dataflow graph compiler 621 may support programming a reconfigurable data processor at higher or lower-level programming languages, for example from an application platform 610 to C++ and assembly language. In some implementations, dataflow graph compiler 621 allows programmers to provide code that runs directly on the reconfigurable data processor. In other implementations, dataflow graph compiler 621 provides one or more libraries that include predefined functions like linear algebra operations, element-wise tensor operations, non-linearities, and reductions required for creating, executing, and profiling the dataflow graphs on the reconfigurable processors. Dataflow graph compiler 621 may provide an application programming interface (API) to enhance functionality available via the application platform 610. As shown in FIG. 6, dataflow graph compiler 621 outputs a dataflow graph that is received by algebraic graph compiler 622.

Algebraic graph compiler 622 may include a model analyzer and compiler (MAC) level that makes high-level mapping decisions for (subgraphs of the) dataflow graph based on hardware constraints. In some implementations, the algebraic graph compiler 622 may support various application frontends such as Samba, JAX, and TensorFlow/HLO. If desired, the algebraic graph compiler 622 may transform the graphs via autodiff and GradNorm, perform stitching between subgraphs, interface with template generators for performance and latency estimation, convert dataflow graph operations to arithmetic or algebraic intermediate representation (AIR) operations, perform tiling, sharding (database partitioning) and other operations, and model or estimate the parallelism that can be achieved on the dataflow graph.

Algebraic graph compiler 622 may further include an arithmetic or algebraic intermediate representation (AIR) level that translates high-level graph and mapping decisions provided by the MAC level into explicit AIR/Tensor statements and one or more corresponding algebraic graphs. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

Thus, algebraic graph compiler 622 replaces the user program statements of a dataflow graph by AIR/Tensor statements of an AIR/Tensor computation graph (AIR graph). As shown in FIG. 6, algebraic graph compiler 622 provides the AIR graph to template graph compiler 623.

Template graph compiler 623 may translate AIR/Tensor statements of an AIR graph into template library intermediate representation (TLIR) statements of a TLIR graph, optimizing for the target hardware architecture into unplaced variable-sized units (referred to as logical CGR units) suitable for PNR 625. Such a TLIR graph is sometimes also referred to as an “operation unit graph” and the unplaced-variable-sized units as “logical units” or “nodes”. So-called “Logical edges” or simply “edges” in the operation unit graph may couple the logical units.

Template graph compiler 623 may allocate metapipelines for sections of the template dataflow statements and corresponding sections of unstitched template computation graph. Template graph compiler 623 may add further information (e.g., name, inputs, input names and dataflow description) for PNR 625 and make the graph physically realizable through each performed step. For example, template graph compiler 623 may provide translation of AIR graphs to specific model operation templates such as for general matrix multiplication (GeMM). An implementation may convert part or all intermediate representation operations to templates, which are sometimes also referred to as “template nodes”, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units, which are commonly referred to as logical units, with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 624 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

In some implementations, the assembler may generate assembler code for a logical unit, whereby the assembler code is associated with a data operation that is to be executed by the logical unit. The logical units of an operation unit graph may include (e.g., store) the assembler code that is associated with the respective data operations of the respective logical units, if desired.

The template graph compiler 623 may also determine control signals, as well as control gates that are required to enable the CGR units (whether logical or physical) to coordinate dataflow between the CGR units in the CGR array of a CGR processor.

PNR 625 translates and maps logical (i.e., unplaced physically realizable) units (e.g., the nodes of the operation unit graph) and edges (e.g., the edges of the operation unit graph) to a physical layout of reconfigurable processor 650, e.g., a physical array of CGR units in a semiconductor chip. PNR 625 also determines physical data channels, which are sometimes also referred to as “physical links”, to enable communication among the CGR units and between the CGR units and circuits coupled via the TLN or the ALN; allocates ports on the CGR units and switches; provides configuration data and initialization data for the target hardware; and produces configuration files, e.g., processor-executable format (PEF) files.

If desired, PNR 625 may provide bandwidth calculations, allocate network interfaces such as AGCUs and virtual address generators (VAGs), provide configuration data that allows AGCUs and/or VAGs to perform address translation, and control ALN switches and data routing. PNR 625 may provide its functionality in multiple steps and may include multiple modules (not shown in FIG. 6) to provide the multiple steps, e.g., a placer, a router, a port allocator, and a PEF file generator.

Illustratively, PNR 625 may receive its input data in various ways. For example, it may receive parts of its input data from any of the earlier modules (e.g., dataflow graph compiler 621, algebraic graph compiler 622, template graph compiler 623, and/or template library 624). In some implementations, an earlier module, such as template graph compiler 623, may have the task of preparing all information for PNR 625 and no other units provide PNR input data directly.

Further implementations of compiler 620 provide for an iterative process, for example by feeding information from PNR 625 back to an earlier module (e.g., to algebraic graph compiler 622). For example, in some implementations, the earlier module may execute a new compilation step in which it uses physically realized results. As shown in FIG. 6, PNR 625 may feed information regarding the physically realized circuits back to algebraic graph compiler 622.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 620 binds memory allocations to unplaced memory units and binds operations specified by operation nodes in the dataflow graph to unplaced compute units, and these bindings may be specified in the configuration data. In some implementations, compiler 620 partitions parts of a dataflow graph into memory subgraphs and compute subgraphs, and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 620 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

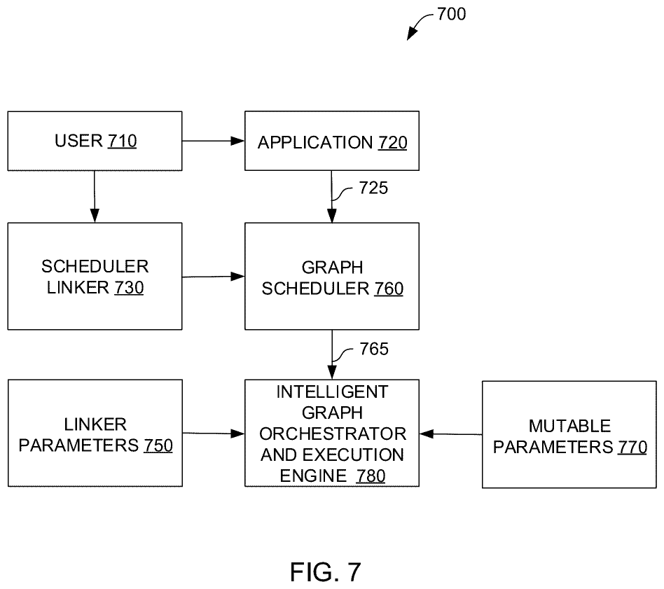

The graph scheduler 660 is configured to receive the dataflow graph from the compiler 620. The dataflow graph includes a static schedule of graph operations and a static schedule of communication operations. The graph scheduler 660 is further configured to receive a user-defined schedule of the graph operations; Illustratively a programming interface such as scheduler linker 730 of FIG. 7 may transmit the user-defined schedule of the graph operations to the graph scheduler 660. After having received the dataflow graph, the static schedule of the graph operations, and the user-defined schedule of the graph operations, the graph scheduler is further configured to generate a new schedule of the graph operations that is different than the static schedule of the graph operations based on the user-defined schedule of the graph operations and the static schedule of the graph operations. For example, the graph scheduler 660 may be configured to use the instructions from the static schedule of graph operations as building blocks for generating the new schedule of graph operations.

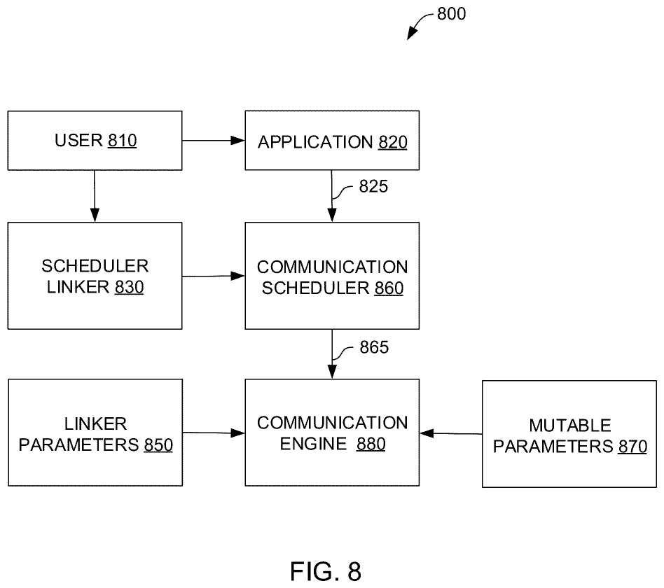

The communication scheduler 670 is configured to receive the dataflow graph with the static schedule of the communication operations from the compiler. The communication scheduler 670 is further configured to receive a user-defined schedule of the communication operations. Illustratively a programming interface such as scheduler linker 830 of FIG. 8 may transmit the user-defined schedule of the communication operations to the communication scheduler 670. After having received the dataflow graph, the static schedule of the communication operations, and the user-defined schedule of the communication operations, the communication scheduler 670 is further configured to generate a new schedule of the communication operations that is different than the static schedule of the communication operations based on the user-defined schedule of the communication operations and the static schedule of the communication operations.

As shown in FIG. 6, the system 600 may include an intelligent graph orchestrator and execution engine 680. The intelligent graph orchestrator and execution engine 680 may be configured to receive the dataflow graph and the new schedule of the graph operations from the graph scheduler 660, receive linker parameters and mutable parameters 640, and schedule instructions within the graph operations using the linker parameters and the mutable parameters. Thus, for each time step, the intelligent graph orchestrator and execution engine 680 determines the hardware states that are executed. Illustratively, the intelligent graph orchestrator and execution engine 680 may profile predetermined operations for a given time step. The predetermined operations may either be fused or combined to be a single operation, if desired.

In some implementations, the system may include a communication engine 690. For example, the communication engine 690 may perform peer-to-peer (P2P) communications and/or use primitives from a collective communication library. The communication engine 690 may be configured to receive the dataflow graph and the new schedule of the communication operations from the communication scheduler 670, receive linker parameters and mutable parameters 640, and implement communication operations using the linker parameters and the mutable parameters.

The runtime execution engine 630 is configured to receive the dataflow graph, the new schedule of the graph operations, and the new schedule of the communication operations. The runtime execution engine 630 configures the array of reconfigurable units of the reconfigurable processor 650 to execute the dataflow graph as defined in the new schedule of the graph operations and in the new schedule of the communication operations and manages execution of the dataflow graph on the reconfigurable processor 650.

FIG. 7 is a diagram of an illustrative graph scheduler 760. The graph scheduler 760 receives an application 720. For example, user 710 may provide the application 720, and the graph scheduler 760 receives a dataflow graph 725 with a static schedule of graph operations of the application 720 from a compiler such as compiler 620 of FIG. 6. By way of example, the compiler may determine a graph topology of the dataflow graph and generate the static schedule of the graph operations based on the graph operations and the graph topology.

Illustratively, a user 710 may interact with the graph scheduler 760 through a programming interface. For example, the graph scheduler 760 receives a user-defined schedule of graph operations from the user 710 via scheduler linker 730. In some implementations, the user 710 may provide a dependency graph of the graph operations to the scheduler linker 730. The scheduler linker 730 may generate the user-defined schedule of the graph operations based on the dependency graph of the graph operations, and provide the user-defined scheduler of the graph operations to the graph scheduler 760.

The graph scheduler 760 generates a new schedule of the graph operations that is different than the static schedule of the graph operations based on the user-defined schedule of the graph operations and the static schedule of the graph operations.

Consider the scenario in which the static schedule of the graph operations includes instructions A, B, C, D, E in this order. As an example, consider further that the user-defined schedule may define that the instructions are to be executed in the order A, D, E, B, C. In this scenario, the graph scheduler 760 may provide a new schedule of the instructions in the order A, D, E, B, C. As another example, consider further that the user-defined schedule may define that the instruction A is to be executed twice, followed by C thrice, which is followed by B, D, and E. In this scenario, the graph scheduler 760 may provide a new schedule of the instructions in the order A, A, C, C, C, B, D, E.

It should be noted that the static schedule, the user-defined schedule, and the new schedule of graph operations not only refer to the order of the graph operations, but also include execution instructions for executing the graph operations. For example, the static schedule, the user-defined schedule, and the new schedule of graph operations may include execution instructions related to the memory location of configuration files and arguments, if desired.

Thus, the graph scheduler 760 may dynamically change the order in which the instructions A, B, C, D, E are executed. If desired, the graph scheduler 760 may determine how the instructions link to each other, determine the metadata that may flow between the instructions, and provide a new schedule of those instructions which may be executed in that order. In other words, the graph scheduler 760 supports dynamic graph scheduling with the schedule linker 730 based on interpreting an initial runtime-defined static graph topology and provides a new schedule of the graph operations to the intelligent graph orchestrator and execution engine (IGOEE) 780. The IGOEE 780 may be configured to receive the dataflow graph with the new schedule of the graph operations 765 as well as mutable parameters 770, such as configuration or environment variables, and linker parameters 750. The IGOEE 780 may schedule instructions within the graph operations using the linker parameters 750 and the mutable parameters 770.

In some implementations, the graph scheduler 760, based on the user-defined schedule of the graph operations, may be configured to generate the new schedule of the graph operations by partitioning the graph operations into first graph operations that the runtime execution engine (e.g., runtime execution engine 630 of FIG. 6) executes and second graph operations that the reconfigurable processor (e.g., reconfigurable processor 650 of FIG. 6) executes. Thus, the user 710 may, through the user-defined schedule of the graph operations, partition the graph operations into hardware-accelerated operations and software-managed operations.

If desired, the graph scheduler 760 may dynamically determine (i.e., without a re-compilation of the application 720 or a recompilation of the dataflow graph 725), based on the user-defined schedule of the graph operations which portions of the application 720 are software-managed (i.e., executed by the runtime execution engine) and which portions of the application 720 are hardware-accelerated (i.e., executed by the reconfigurable processor). For example, in the scenario above, the graph scheduler 760 may determine that the runtime execution engine executes instructions A and E, while the reconfigurable processor executes instructions B, C, D.

Illustratively, the graph scheduler 760 may link the graph operations of multiple dataflow graphs together. For example, the graph scheduler 760 may be configured to receive an additional dataflow graph (e.g., for another application other than application 720 with another dataflow graph other than dataflow graph 725) including an additional static schedule of additional graph operations. The graph scheduler 760 may further receive another user-defined schedule of the graph operations and the additional graph operations. By way of example, the graph scheduler 760 may generate another new schedule of the graph operations and the additional graph operations based on the static schedule of the graph operations, the additional static schedule of the additional graph operations, and the other user-defined schedule of the graph operations and the additional graph operations. The other new schedule of the graph operations and the additional graph operations links the graph operations from the dataflow graph with the additional graph operations from the additional dataflow graph.

In some scenarios, the user 710 may have multiple applications 720 and associated multiple dataflow graphs 725. In these scenarios, the user 710 may provide via the scheduler linker 730 a user-defined schedule of graph operations that picks sections out of different dataflow graphs of the multiple dataflow graphs 725 such that the intelligent graph orchestrator and execution engine 780 may parse, interpret, and then unroll the different graph operations in that order on the reconfigurable processor. In other words, the different graph operations may be taken from an ensemble of dataflow graphs and repurposed or unrolled and parsed by the graph scheduler 760, thereby dynamically linking multiple dataflow graphs together.

FIG. 8 is a diagram of an illustrative communication scheduler 860. The communication scheduler 860 receives an application 820. For example, the communication scheduler 860 receives a dataflow graph 825 with a static schedule of communication operations of the application 820 from a compiler such as compiler 620 of FIG. 6. By way of example, the compiler may determine and generate the static schedule of the communication operations based on a topology of required, linked communication operations. Thus, the communications scheduler 860 arranges communication operations between different hardware components for the execution of the dataflow graph.

As an example, consider the scenario in which a system includes a runtime execution engine, a reconfigurable processor with an array of reconfigurable units, and a communication interface device. In this scenario, the communication operations may include at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

Illustratively, the user 810 may interact with the communication scheduler 860 through a programming interface. For example, the communication scheduler 860 receives a user-defined schedule of communication operations from a user 810 via scheduler linker 830. In some implementations, a user 810 may provide links for the communication operations to the scheduler linker 830. The scheduler linker 830 may generate the user-defined schedule of the communication operations based on the links for the communication operations and provide the user-defined schedule of the communication operations to the communication scheduler 860.

The communication scheduler 860 generates a new schedule of the communication operations that is different than the static schedule of the communication operations based on the user-defined schedule of the communication operations and the static schedule of the communication operations.

In some implementations, the communication scheduler 860 may be configured to program the new schedule of the communication operations into the communication interface device. Illustratively, for programming the new schedule of the communication operations into the communication interface device, the communication scheduler 860 may be configured to set up signal and wait communication operations in the communication interface device.

The communication engine 880 may be configured to receive the dataflow graph with the new schedule of the communication operations 865 as well as mutable parameters 870 and linker parameters 850. The communication engine 880 may schedule the communication operations using the linker parameters 850 and the mutable parameters 870.

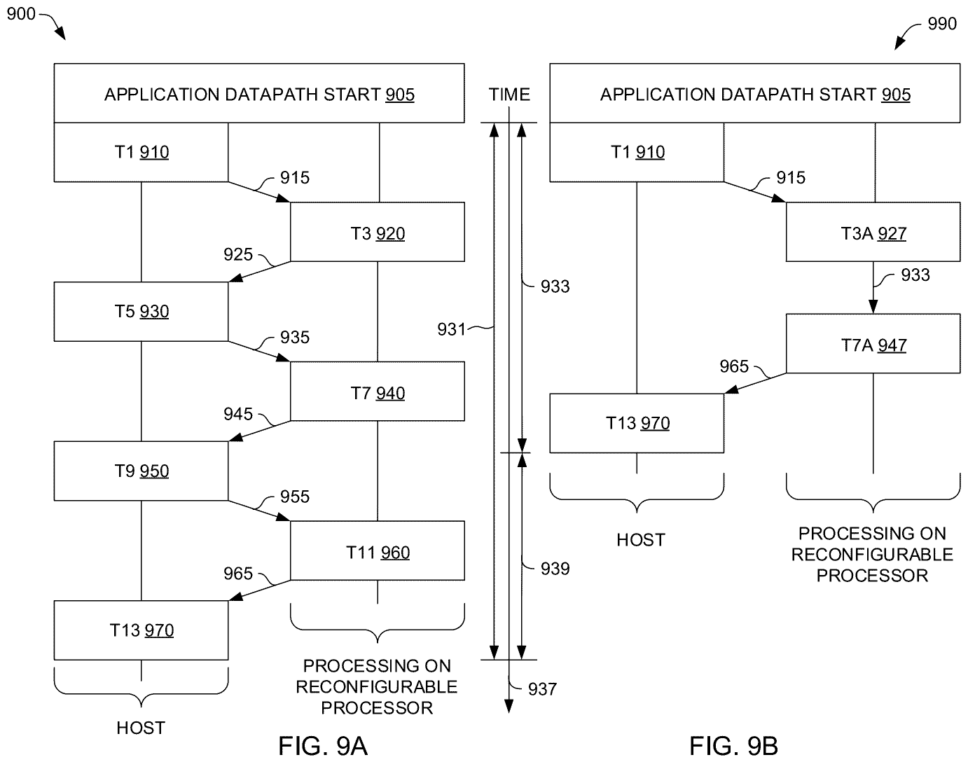

FIG. 9A is a diagram of an illustrative static schedule 900 of graph operations 910, 915, 920, 925, 930, 935, 940, 945, 950, 955, 960, 965, 970. Each graph operation is executed in a host (e.g., runtime execution engine 630 of FIG. 6) or on a reconfigurable processor (e.g., reconfigurable processor 650 of FIG. 6), or transfers data from the host to the reconfigurable processor or from the reconfigurable processor to the host. Each graph operation has an associated duration T measured on a time axis 937. For example, T1, T3, T5, T7, T9, T11, T13 may indicate the time needed to execute graph operation 910, 920, 930, 940, 950, 960, 970, respectively. The total time to execute the graph operations according to the static schedule of graph operations is illustrated as time 931 on time axis 937.

Graph operations 910, 930, 950 may include setting up data structures and registers for running a first section (910), a middle section (930) and a last section (950) of an unrolled dataflow graph. The graph operations 915, 935, 955 may include transferring configuration files and setting up registers to run the first section (915), the middle section (935), and the last section (955) of the unrolled dataflow graph on the array of reconfigurable units of the reconfigurable processor. The graph operations 920, 940, 960 may include processing the first section (920), the middle section (940), and the last section (960) of the dataflow graph on the array of reconfigurable units of the reconfigurable processor, and the graph operations 925, 945, 965 may include returning completion of the first section (925), the middle section (945), and the last section (965) from the reconfigurable processor to the host. Graph operation 970 may include a tear down of data structures and resources for the current session.

Thus, after the application datapath start 905, an execution of a graph operation on the host is followed by an execution of a graph operation on the reconfigurable processor, and an execution of a graph operation on the reconfigurable processor is followed by an execution of a graph operation on the host. In addition to the execution time of the graph operations, the static schedule also requires time for setting up and reporting completion of the respective sections of the dataflow graph.

FIG. 9B is a diagram of an illustrative new schedule 990 of graph operations 910, 915, 927, 933, 947, 965, 970 based on a user-defined schedule of the graph operations and the static schedule of the graph operations of FIG. 9A.

In some implementations, the graph operations 927, 933, and 947 of FIG. 9B may perform the same operations as graph operations 920, 925, 930, 935, 940, 945, 950, 955, 960 of FIG. 9A. As an example, graph operation 927 may include the first section and a portion of the middle section of the unrolled dataflow graph (e.g., graph operation 927 may perform the same operation as graph operations 920, 925, 930, and 935), while graph operation 947 includes the remaining portion of the middle section and the last section of the unrolled dataflow graph (i.e., graph operation 947 performs the same operation as graph operations 940, 945, 950, 955, and 960). As another example, graph operation 927 may include the first section of the unrolled dataflow graph (i.e., graph operation 927 performs the same operation as graph operation 920), and graph operation 947 may include the middle section and the last section of the unrolled dataflow graph (i.e., graph operation 947 performs the same operation as graph operations 925, 930, 935, 940, 945, 950, 955, and 960). As yet another example, graph operation 927 may include the first section and the middle section of the unrolled dataflow graph (i.e., graph operation 927 may perform the same operation as graph operations 920, 925, 930, 935, 940, 945, 950, and 955), and graph operation 947 may include the last section of the unrolled dataflow graph (i.e., graph operations 947 performs the same operation as graph operation 960). Graph operation 933 may include the starting of graph operation 947 after the completion of graph operation 927.

If desired, the graph scheduler may, based on the user-defined schedule of the graph operations, be configured to generate the new schedule of the graph operations by partitioning the graph operations into first graph operations that the runtime execution engine executes on the host and second graph operations that the reconfigurable processor executes.

Graph operation 910 may include setting up data structures and registers for running the unrolled dataflow graph, and graph operation 970 may include a tear down of data structures and resources for the current session. Graph operation 915 may include transferring configuration files and setting up registers to run the unrolled dataflow graph on the array of reconfigurable units of the reconfigurable processor, and graph operation 965 may include returning completion of the unrolled dataflow graph to the host.

The total time to execute the graph operations according to the new schedule of graph operations is illustrated as time 933 on time axis 937. Thus, the total time to execute the graph operations is reduced by duration 939 for the new schedule of the graph operations compared to the static schedule of the graph operations of FIG. 9A. The speed-up of using the new schedule of the graph operations compared to the static schedule of the graph operations may be time 931 divided by time 933.

The reduction in execution time 939 stems from the sequential execution of all sections of the unrolled dataflow graph during graph operations 927, 933, and 947 on the reconfigurable processor. Thereby, the new schedule of the graph operations of FIG. 9B avoids the back and forth between graph operations that are executed by the host and graph operations that are executed by the reconfigurable processor as in the static schedule of the graph operations of FIG. 9A.

FIGS. 9A and 9B are for illustration purposes only. In fact, the dataflow graph of FIGS. 9A and 9B is comparatively very small with a static schedule involving the execution of three graph operations on the reconfigurable processor and a new schedule involving the execution of two graph operations on the reconfigurable processor. In practice, a typical dataflow graph may include thousands of graph operations.

Illustratively, in addition to the reconfigurable processor and the runtime execution engine, the system may include a communication interface device such as, for example, a network interface controller (NIC) that is coupled to the runtime execution engine and to the reconfigurable processor. Communication operations may include at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

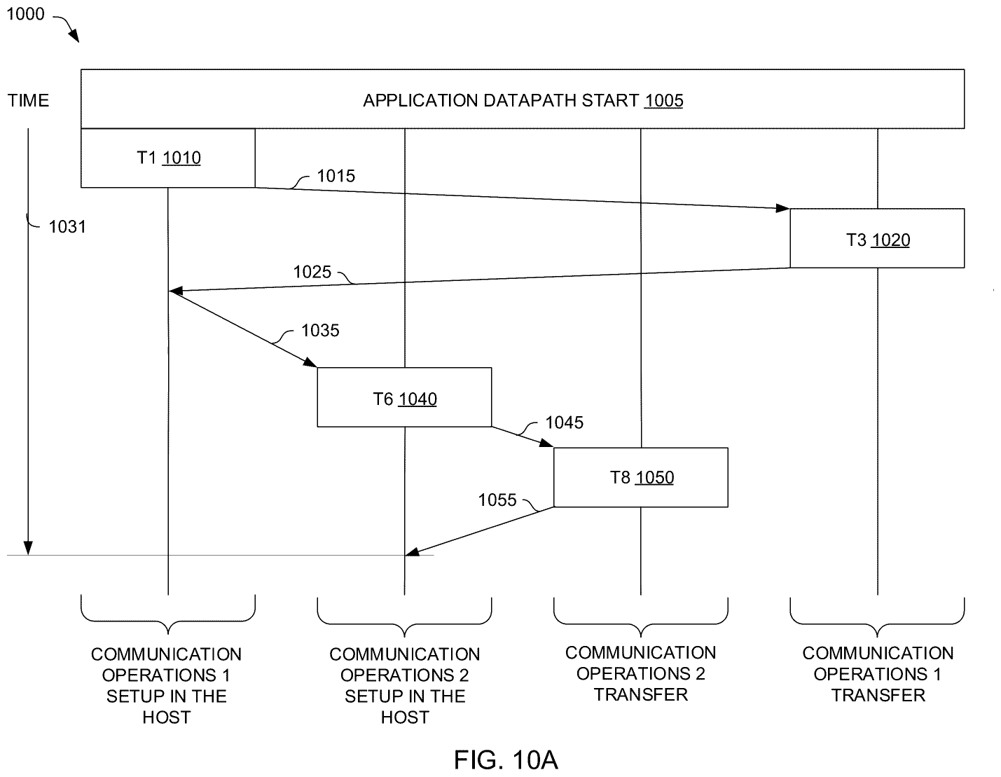

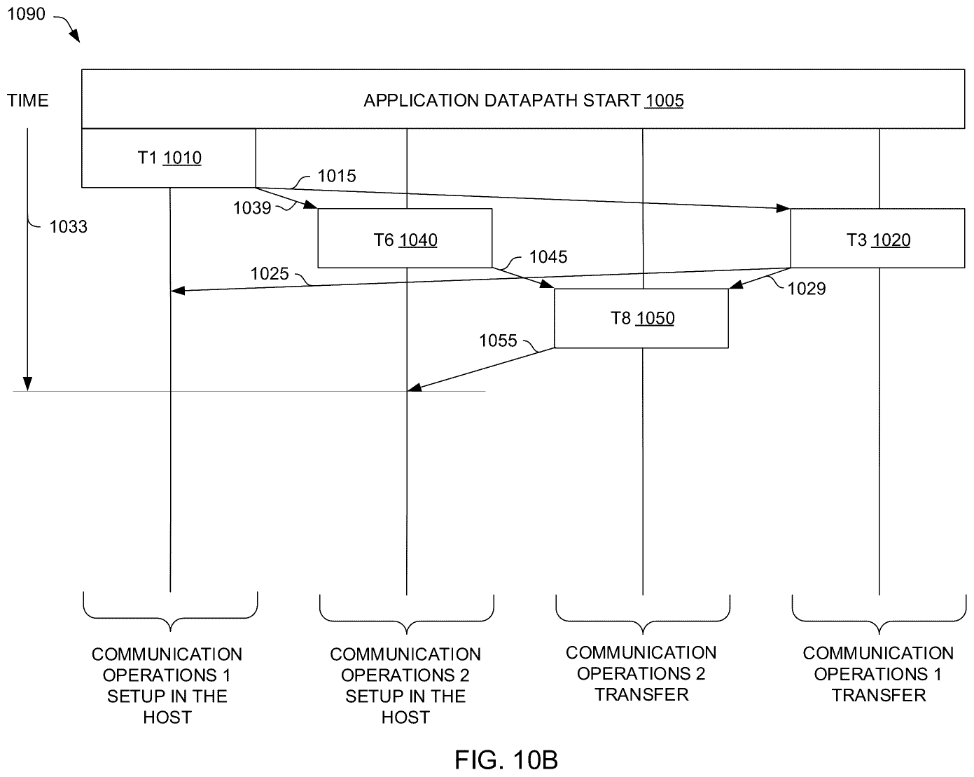

FIG. 10A is a diagram of an illustrative static schedule of communication operations 1000. As shown in FIG. 10A, there are four different series of contexts that execute communication operations: the setup of communication operations 1 and 2 in the host and the transfer of the communication operations.

Illustratively, the static schedule of communication operations may include communication operations 1010, 1015, 1020, 1025, 1035, 1040, 1045, 1050, 1055 in this order. Communication operation 1010 may include setting up and programming of the communication operation 1 registers for data transfer. Communication operation 1015 may include the context switch from the communication operations 1 setup context in the host to the communication operations 1 transfer context. Communication operation 1020 may include a communication operations 1 transfer from a local to a target memory via a communication interface device. Communication operation 1025 may include the context switch from the communication operations 1 transfer context to the communication operations 1 setup context in the host after the completion of communication operation 1020. Communication operation 1035 may include the context switch from the communication operations 1 setup context in the host to the communication operations 2 setup context in the host. Communication operation 1040 may include the setting up and programming of the communication operation 2 registers for data transfer. Communication operation 1045 may include the context switch from the communication operations 2 setup context in the host to the communication operations 2 transfer context. Communication operation 1050 may include a communication operations 2 transfer from another local to another target memory via the communication interface device. Communication operation 1055 may include the context switch from the communication operations 2 transfer context to the communication operations 2 setup context in the host after the completion of communication operation 1050.

Each communication operation has an associated duration T measured on a time axis. For example, T1, T3, T6, T8 may indicate the time needed to perform communication operations 1010, 1020, 1040, 1050, respectively. The total time to execute the communication operations according to the static schedule of communication operations after the application datapath start 1005 is illustrated as time 1031 on the time axis.

FIG. 10B is a diagram of an illustrative new schedule of communication operations 1090 based on a user-defined schedule of the communication operations and the static schedule of the communication operations of FIG. 10A. As an example, a user (e.g., user 810 of FIG. 8) may provide a user-defined schedule of the communication operations (e.g., via scheduler linker 830 of FIG. 8), and a communication scheduler (e.g., communication scheduler 860 of FIG. 8) generates the new schedule of communication operations 1090 based on the user-defined schedule of the communication operations and the static schedule of communication operations (e.g., received with dataflow graph 825 of FIG. 8).

As illustrated in FIG. 10B, there is no dependency between communication operation 1020 and communication 1040. Thus, communication operation 1040 can be performed at the same time as communication operation 1020. The new schedule of communication operations, after having performed communication operation 1010 performs a context switch from the communication operations 1 setup context in the host not only via communication operation 1015 to the communications operations 1 transfer context but at the same time via communication operation 1039 to the communication operations 2 setup context in the host so that communication operations 1020 and 1040 can be performed in parallel. Please note that communication operations 1010 and 1040 are shown serialized in this example to illustrate the case of a context switch from the communication operations 1 setup context in the host to the communication operations 2 setup context in the host. If desired, communication operations 1010 and 1040 may be performed in parallel.

Communication operation 1045 (i.e., the context switch from the communication operations 2 setup context in the host to the communication operations 2 transfer context) can occur after the end of communication operation 1040. However, communication operation 1050 is dependent on the completion of communication operation 1020. Therefore, communication operation 1050 only starts after communication operation 1029 has completed, which involves a context switch from the communication operations 1 transfer context to the communication operations 2 transfer context.

The total time to execute the communication operations according to the new schedule of communication operations after the application datapath start 1005 is illustrated as time 1033 on the time axis. Thus, the total time to execute the communication operations is reduced for the new schedule of the communication operations compared to the static schedule of the communication operations of FIG. 10A. The speed-up of using the new schedule of the communication operations compared to the static schedule of the communication operations may be time 1031 divided by time 1033.

The reduction in time stems from the parallelization of communication operations 1020 and 1040. Furthermore, the new schedule of the communication operations of FIG. 10B avoids waiting for completion of context switches associated with communication operations 1025 and 1035 of FIG. 10A.

In some implementations, the communication scheduler may be configured to program the new schedule of the communication operations 1090 in the communication interface device. In the scenario in which multiple reconfigurable processors that each have their local communication interface device are used to implement a dataflow graph, the communication scheduler may be configured to program the new schedule of the communication operations 1050 in the local communication interface device and in any peer communication interface device.

For programming the new schedule of the communication operations in the communication interface device, the communication scheduler may be configured to set up signal and wait communication operations in the communication interface device. If desired, the communication scheduler may define the order of communication operations in the communication interface device. Thus, the local and peer communication interface devices may unroll the communication operations without host interaction. Without host interaction, the communication operations may wait on each other.

In some implementations, the communication scheduler may be configured to pipeline first and second communication operations (e.g., large communication operations) of the communication operations into first and second communication sub-operations (e.g., smaller sub-operations of the large communication operations).

Illustratively, the communication scheduler may be configured to generate the new schedule of the communication operations by parallelizing independent communication operations or communication sub-operations based on the user-defined schedule of the communication operations.

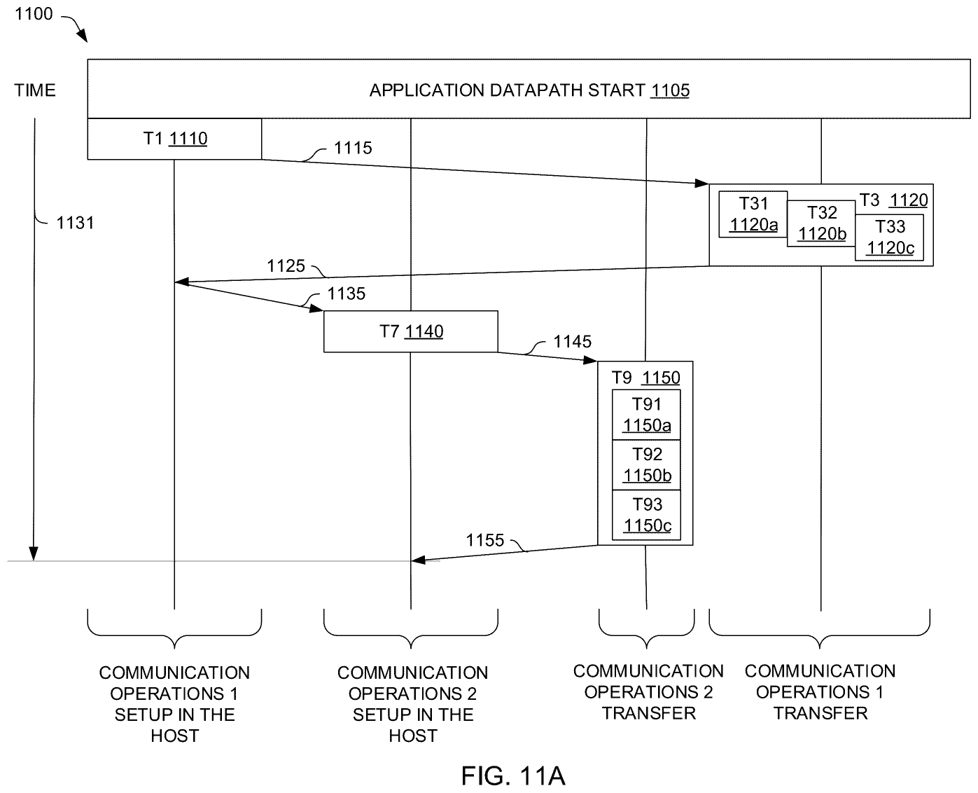

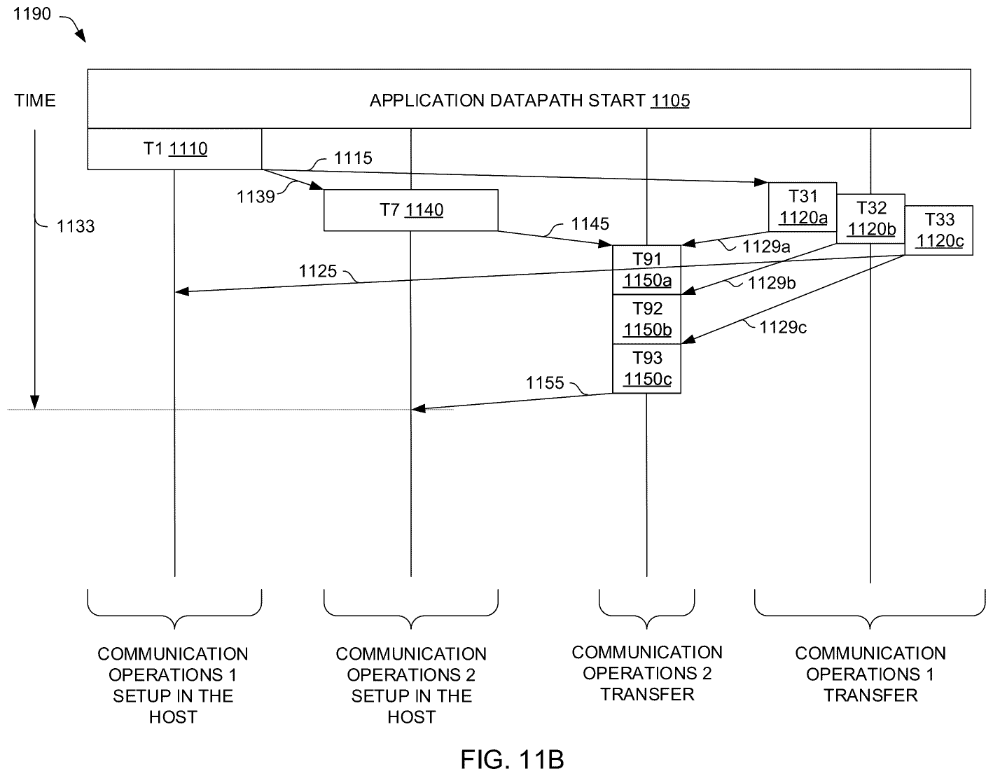

FIG. 11A is a diagram of an illustrative static schedule of communication operations 1100 that can be pipelined and parallelized. As shown in FIG. 11A, there are four different series of contexts that execute communication operations: the setup of communication operations 1 and 2 in the host and the transfer of the communication operations.

Illustratively, the static schedule of communication operations may include communication operations 1110, 1115, 1120, 1125, 1135, 1140, 1145, 1150, 1155 in this order. Communication operation 1110 may include setting up and programming of the communication operation 1 registers for data transfer. Communication operation 1115 may include the context switch from the communication operations 1 setup context in the host to the communication operations 1 transfer context. Communication operation 1120 may include a communication operations 1 transfer from a local to a target memory via a communication interface device. Communication operation 1125 may include the context switch from the communication operations 1 transfer context to the communication operations 1 setup context in the host after the completion of communication operation 1120. Communication operation 1135 may include the context switch from the communication operations 1 setup context in the host to the communication operations 2 setup context in the host. Communication operation 1140 may include the setting up and programming of the communication operation 2 registers for data transfer. Communication operation 1145 may include the context switch from the communication operations 2 setup context in the host to the communication operations 2 transfer context. Communication operation 1150 may include a communication operations 2 transfer from another local to another target memory via the communication interface device. Communication operation 1155 may include the context switch from the communication operations 2 transfer context to the communication operations 2 setup context in the host after the completion of communication operation 1150.

Illustratively, communication operation 1120 may be pipelined into communication sub-operations 1120a, 1120b, 1120c, and communication operation 1150 may be pipelined into communication sub-operations 1150a, 1150b, 1150c.

Each communication operation has an associated duration time T measured on a time axis. For example, T1, T3, T7, T9 may indicate the time needed to perform communication operations 1110, 1120, 1140, 1150, and T31, T32, T33, T91, T92, T93 may indicate the time needed to perform communication sub-operations 1120a, 1120b, 1120c, 1150a, 1150b, 1150c, respectively. The total time to execute the communication operations according to the static schedule of communication operations after the application datapath start 1105 is illustrated as time 1131 on the time axis.

In the example of FIG. 11A, each communication sub-operation 1150a, 1150b, 1150c of the second communication sub-operations may dependent on a completion of a corresponding communication sub-operation 1120a, 1120b, 1120c of the first communication sub-operations. Thus, the communication scheduler may be configured to generate the new schedule of the communication operations by scheduling each communication sub-operation of the second communication sub-operations 1150a, 1150b, 1150c after the corresponding communication sub-operation of the first communication sub-operations 1120a, 1120b, 1120c.

FIG. 11B is a diagram of an illustrative modified pipelined and parallelized schedule of communication operations 1190 based on a user-defined schedule of the communication operations and the static schedule of the communication operations 1100 of FIG. 11A.

As an example, a user (e.g., user 810 of FIG. 8) may provide a user-defined schedule of the communication operations (e.g., via scheduler linker 830 of FIG. 8), and a communication scheduler (e.g., communication scheduler 860 of FIG. 8) generates the new schedule of communication operations 1190 based on the user-defined schedule of the communication operations and a static schedule of communication operations (e.g., received with dataflow graph 825).

As illustrated in FIG. 11B, there is no dependency between communication sub-operations 1120a, 1120b, 1120c and communication 1140. Thus, communication operation 1140 can be performed at the same time as communication sub-operations 1120a, 1120b, 1120c. The new schedule of communication operations, after having performed communication operation 1110 performs a context switch from the communication operations 1 setup context in the host not only via communication operation 1115 to the communications operations 1 transfer context, but at the same time via communication operation 1139 to the communication operations 2 setup context in the host. Thus, communication sub-operations 1120a, 1120b, 1120c, and 1140 can be performed in parallel.

Communication operation 1145 (i.e., the context switch from the communication operations 2 setup context in the host to the communication operations 2 transfer context) can occur after the end of communication operation 1140. However, communication sub-operation 1150a is dependent on the completion of communication sub-operation 1120a, but independent of the completion of communication sub-operations 1120b and 1120c. Therefore, communication sub-operation 1150a can start after communication sub-operation 1129a, which involves a context switch from the communication operations 1 transfer context to the communication operations 2 transfer context after the completion of communication operation 1120a, has been performed. Similarly, communication sub-operation 1150b may depend on the completion of communication sub-operations 1120b and 1150a. Therefore, communication sub-operation 1150b can start after the completion of communication sub-operation 1150a and the completion of communication sub-operation 1129b, the latter involving a context switch from the communication operations 1 transfer context to the communication operations 2 transfer context. As shown in FIG. 11B, communication sub-operation 1150c may depend on the completion of communication sub-operations 1120c and 1150b. Therefore, communication sub-operation 1150c can start after the completion of communication sub-operation 1150b and the completion of communication sub-operation 1129c, the latter involving a context switch from the communication operations 1 transfer context to the communication operations 2 transfer context.

The total time needed to execute the communication operations according to the new schedule of communication operations after the application datapath start 1105 is illustrated as time 1133 on the time axis. Thus, the total time to execute the communication operations is reduced for the new schedule of the communication operations compared to the static schedule of the communication operations of FIG. 11A. The speed-up of using the new schedule of the communication operations compared to the static schedule of the communication operations may be time 1131 divided by time 1133.

The reduction in time stems from the parallelization of communication operations 1020 and 1040. Furthermore, the new schedule of the communication operations of FIG. 11B avoids waiting for completion of context switches associated with communication operations 1125 and 1135 of FIG. 11A. Moreover, communication operations 1120 and 1150 can be pipelined and parallelized. For example, communication sub-operation 1150a is independent of communication sub-operations 1120b and 1120c and can be performed after the completion of communication sub-operation 1120a and communication operations 1129a.

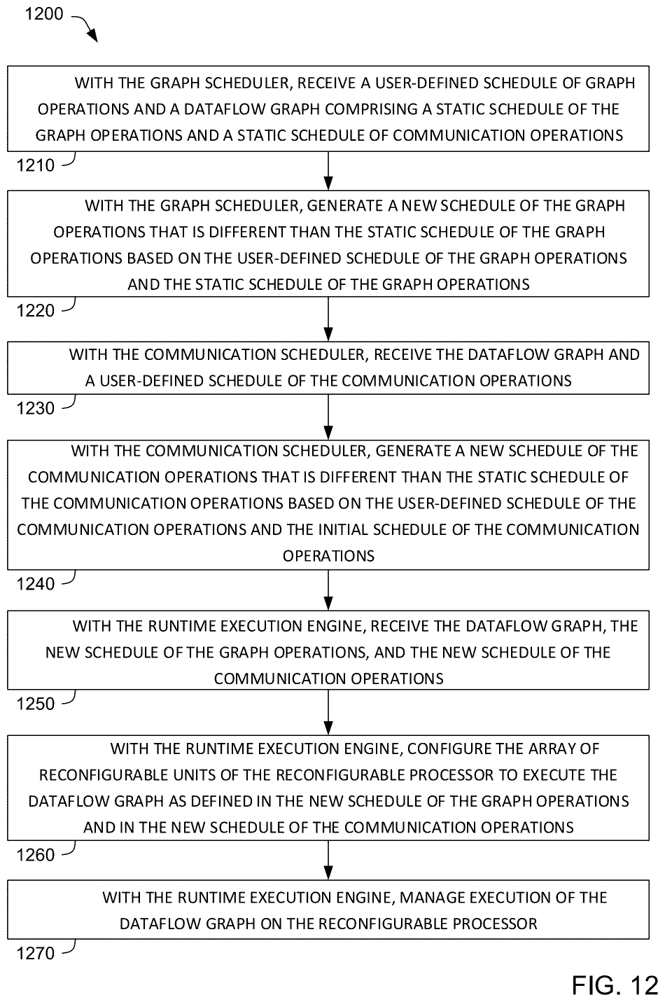

FIG. 12 is a flowchart 1200 showing illustrative operations that a system (e.g., system 600 of FIG. 6) including a runtime execution engine, a graph scheduler, a communication scheduler, and a reconfigurable processor with an array of reconfigurable units performs for implementing and executing a dataflow graph.

During operation 1210, the graph scheduler receives a user-defined schedule of graph operations and a dataflow graph comprising a static schedule of the graph operations and a static schedule of communication operations. For example, the graph scheduler 760 of FIG. 7 may receive a user-defined schedule of graph operations from a user 710 via scheduler linker 730 and a dataflow graph 725 with a static schedule of the graph operations (e.g., static schedule 900 of FIG. 9A) and a static schedule of the communication operations (e.g., static schedule 1000 of FIG. 10A).

During operation 1220, the graph scheduler generates a new schedule of the graph operations that is different than the static schedule of the graph operations based on the user-defined schedule of the graph operations and the static schedule of the graph operations. For example, the graph scheduler 760 of FIG. 7 may generate a new schedule of the graph operations (e.g., new schedule 990 of FIG. 9B) that is different than the static schedule of the graph operations (e.g., static schedule 900 of FIG. 9A) based on the user-defined schedule of the graph operations received via scheduler linker 730 and the static schedule of the graph operations.

During operation 1230, the communication scheduler receives the dataflow graph and a user-defined schedule of the communication operations. For example, the communication scheduler 860 of FIG. 8 may receive the dataflow graph 825 and a user-defined schedule of the communication operations from a user 810 via scheduler linker 830.

During operation 1240, the communication scheduler generates a new schedule of the communication operations that is different than the static schedule of the communication operations based on the user-defined schedule of the communication operations and the static schedule of the communication operations. For example, the communication scheduler 860 of FIG. 8 may generate the new schedule of the communication operations (e.g., new schedule 1090 of FIG. 10B) that is different than the static schedule of the communication operations (e.g., static schedule 1000 of FIG. 10A) based on the user-defined schedule of the communication operations received via scheduler linker 830 and the static schedule of the communication operations.

During operation 1250, the runtime execution engine receives the dataflow graph, the new schedule of the graph operations, and the new schedule of the communication operations. For example, the runtime execution engine 630 of FIG. 6 may receive the dataflow graph, the new schedule of the graph operations (e.g., new schedule 990 of FIG. 9B) and the new schedule of the communication operation (e.g., new schedule 1090 of FIG. 10B).

During operation 1260, the runtime execution engine configures the array of reconfigurable units of the reconfigurable processor to execute the dataflow graph as defined in the new schedule of the graph operations and in the new schedule of the communication operations. For example, the runtime execution engine 630 of FIG. 6 may configure the array of reconfigurable units of the reconfigurable processor 650 to execute the dataflow graph as defined in the new schedule of the graph operations (e.g., new schedule 990 of FIG. 9B) and in the new schedule of the communication operations (e.g., new schedule 1090 of FIG. 10B).

During operation 1270, the runtime execution engine manages execution of the dataflow graph on the reconfigurable processor. For example, runtime execution engine 630 of FIG. 6 may manage execution of the dataflow graph on the reconfigurable processor 650.

Illustratively, the graph scheduler may generate a new schedule of the graph operations based on the static schedule of the graph operations (e.g., static schedule 900 of FIG. 9A) by partitioning the graph operations into first graph operations that the runtime execution engine executes and second graph operations that the reconfigurable processor executes. For example, the graph scheduler may partition graph operations such as register programming, configuration of the reconfigurable processor, or communication operations into operations that the runtime execution engine executes and operations that the reconfigurable processor executes. Some graph operations such as the graph setup and parsing of the schedule may be exclusively executed by the runtime execution engine, and other graph operations such as the actual execution of each graph operation, loading of a program and arguments may be exclusively executed by the reconfigurable processor.

In some implementations, the runtime execution engine may execute a setup operation (e.g., graph operation 910 of FIGS. 9A and 9B) of the first graph operations before the reconfigurable processor starts to execute the second graph operations and a tear-down operation (e.g., graph operation 970 of FIGS. 9A and 9B) of the first graph operations after the reconfigurable processor has finished to execute the second graph operations.

By way of example, the graph scheduler may receive an additional dataflow graph comprising an additional static schedule of additional graph operations, receive another user-defined schedule of the graph operations and the additional graph operations, and generate another new schedule of the graph operations and the additional graph operations based on the static schedule of the graph operations, the additional static schedule of the additional graph operations, and the other user-defined schedule of the graph operations and the additional graph operations, whereby the other new schedule of the graph operations and the additional graph operations links the graph operations from the dataflow graph with the additional graph operations from the additional dataflow graph.

Illustratively the system may include a communication interface device. The communication interface device may be coupled to the runtime execution engine and to the reconfigurable processor. In the system with the communication interface device, the runtime execution engine, and the reconfigurable processor with the array of reconfigurable units, the communication operations may include at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

In some implementations, the communication scheduler may program the new schedule of the communication operations in the communication interface device by setting up signal and wait communication operations in the communication interface device.

If desired, generating the new schedule of the communication operations may include parallelizing independent communication operations based on the user-defined schedule of the communication operations with the communication scheduler.

Illustratively, the communication scheduler may pipeline first and second communication operations of the communication operations into first and second communication sub-operations. As an example, communication operations 1120 and 1150 of FIG. 11A may be pipelined into communication sub-operations 1120a, 1120b, 1120c and 1150a, 1150b, 1150c, respectively, as shown in FIG. 11B. In some scenarios, each communication sub-operation of the second communication sub-operations may be dependent on a completion of a corresponding communication sub-operation of the first communication sub-operations. In such scenarios, the communication scheduler may generate the new schedule of the communication operations by scheduling each communication sub-operation of the second communication sub-operations after the corresponding communication sub-operation of the first communication sub-operations.

If desired, a non-transitory computer-readable storage medium includes instructions that, when executed by a processing unit (e.g., host processor 180 of FIG. 1), cause the processing unit to operate a system (e.g., the system 600 of FIG. 6, whereby the system includes a runtime execution engine (e.g., runtime execution engine 630 of FIG. 6), a graph scheduler (e.g., graph scheduler 660 of FIG. 6), a communication scheduler (e.g., communication scheduler 670 of FIG. 6), and a reconfigurable processor with an array of reconfigurable units (e.g., reconfigurable processor 650 of FIG. 6).

The instructions include receiving a user-defined schedule of graph operations, a user-defined schedule of communication operations, and a dataflow graph comprising a static schedule of the graph operations and a static schedule of the communication operations; generating a new schedule of the graph operations that is different than the static schedule of the graph operations based on the user-defined schedule of the graph operations and the static schedule of the graph operations; generating a new schedule of the communication operations that is different than the static schedule of the communication operations based on the user-defined schedule of the communication operations and the static schedule of the communication operations; configuring the array of reconfigurable units of the reconfigurable processor to execute the dataflow graph as defined in the new schedule of the graph operations and in the new schedule of the communication operations; and managing execution of the dataflow graph on the reconfigurable processor.

While the present technology is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

As will be appreciated by those of ordinary skill in the art, aspects of the presented technology may be embodied as a system, device, method, or computer program product apparatus. Accordingly, elements of the present disclosure may be implemented entirely in hardware, entirely in software (including firmware, resident software, micro-code, or the like) or in software and hardware that may all generally be referred to herein as an “apparatus,” “circuit,” “circuitry,” “module,” “computer,” “logic,” “FPGA,” “unit,” “system,” or other terms.

Furthermore, aspects of the presented technology may take the form of a computer program product embodied in one or more computer-readable medium(s) having computer program code stored thereon. The phrases “computer program code” and “instructions” both explicitly include configuration information for a CGRA, an FPGA, or other programmable logic as well as traditional binary computer instructions, and the term “processor” explicitly includes logic in a CGRA, an FPGA, or other programmable logic configured by the configuration information in addition to a traditional processing core. Furthermore, “executed” instructions explicitly includes electronic circuitry of a CGRA, an FPGA, or other programmable logic performing the functions for which they are configured by configuration information loaded from a storage medium as well as serial or parallel execution of instructions by a traditional processing core.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random-access memory, the data storage in a computer-readable storage medium can be considered to be non-transitory.

A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of the present technology may be written in any combination of one or more programming languages, including object-oriented programming languages such as Java, Python, C++, or the like, conventional procedural programming languages, such as the “C” programming language or similar programming languages, or low-level computer languages, such as assembly language or microcode. In addition, the computer program code may be written in VHDL, Verilog, or another hardware description language to generate configuration instructions for an FPGA, CGRA IC, or other programmable logic.

The computer program code if converted into an executable form and loaded onto a computer, FPGA, CGRA IC, or other programmable apparatus, produces a computer implemented method. The instructions which execute on the computer, FPGA, CGRA IC, or other programmable apparatus may provide the mechanism for implementing some or all of the functions/acts specified in the flowchart and/or block diagram block or blocks. In accordance with various implementations, the computer program code may execute entirely on the user's device, partly on the user's device and partly on a remote device, or entirely on the remote device, such as a cloud-based server. In the latter scenario, the remote device may be connected to the user's device through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So, a processor programmed to perform a task is transformed from what the processor was before being programmed to perform that task, much like a physical plumbing system with different valves can be controlled to change the physical flow of a fluid.

Example 1 is a system comprising: a reconfigurable processor comprising an array of reconfigurable units; a graph scheduler configured to: receive a dataflow graph comprising a static schedule of graph operations and a static schedule of communication operations from a compiler, receive a user-defined schedule of the graph operations, and generate a new schedule of the graph operations that is different than the static schedule of the graph operations based on the user-defined schedule of the graph operations and the static schedule of the graph operations; a communication scheduler configured to: receive the dataflow graph from the compiler, receive a user-defined schedule of the communication operations, and generate a new schedule of the communication operations that is different than the static schedule of the communication operations based on the user-defined schedule of the communication operations and the static schedule of the communication operations; and a runtime execution engine configured to: receive the dataflow graph, the new schedule of the graph operations, and the new schedule of the communication operations, configure the array of reconfigurable units of the reconfigurable processor to execute the dataflow graph as defined in the new schedule of the graph operations and in the new schedule of the communication operations, and manage execution of the dataflow graph on the reconfigurable processor.

In Example 2, the system of Example 1 further comprises a programming interface that transmits the user-defined schedule of the graph operations to the graph scheduler and the user-defined schedule of the communications operations to the communication scheduler.

In Example 3, the system of Example 1 further comprises an intelligent graph orchestrator and execution engine that is configured to: receive the dataflow graph and the new schedule of the graph operations; receive linker parameters and mutable parameters; and schedule instructions within the graph operations using the linker parameters and the mutable parameters.

In Example 4, the graph scheduler of Example 1, based on the user-defined schedule of the graph operations, is further configured to generate the new schedule of the graph operations by partitioning the graph operations into first graph operations that the runtime execution engine executes and second graph operations that the reconfigurable processor executes.

In Example 5, the runtime execution engine of Example 4 is further configured to: execute a setup operation of the first graph operations before the reconfigurable processor starts to execute the second graph operations; and execute a tear-down operation of the first graph operations after the reconfigurable processor has finished to execute the second graph operations.

In Example 6, the graph scheduler of Example 1 is further configured to: receive an additional dataflow graph comprising an additional static schedule of additional graph operations from a compiler; receive another user-defined schedule of the graph operations and the additional graph operations; and generate another new schedule of the graph operations and the additional graph operations based on the static schedule of the graph operations, the additional static schedule of the additional graph operations, and the other user-defined schedule of the graph operations and the additional graph operations, wherein the other new schedule of the graph operations and the additional graph operations links the graph operations from the dataflow graph with the additional graph operations from the additional dataflow graph.

In Example 7, the system of Example 1 further comprises a communication interface device that is coupled to the runtime execution engine and to the reconfigurable processor, and wherein the communication operations comprise at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

In Example 8, the communication scheduler of Example 7 is further configured to program the new schedule of the communication operations in the communication interface device.

In Example 9, the communication scheduler of Example 8, for programming the new schedule of the communication operations in the communication interface device, is further configured to set up signal and wait communication operations in the communication interface device.

In Example 10, the communication scheduler of Example 7 is further configured to generate the new schedule of the communication operations by parallelizing independent communication operations based on the user-defined schedule of the communication operations.

In Example 11, the communication scheduler of Example 7 is further configured to pipeline first and second communication operations of the communication operations into first and second communication sub-operations, wherein each communication sub-operation of the second communication sub-operations is dependent on a completion of a corresponding communication sub-operation of the first communication sub-operations; and generate the new schedule of the communication operations by scheduling each communication sub-operation of the second communication sub-operations after the corresponding communication sub-operation of the first communication sub-operations.

Example 12 is a method of operating a system that comprises a runtime execution engine, a graph scheduler, a communication scheduler, and a reconfigurable processor comprising an array of reconfigurable units, the method comprising: with the graph scheduler, receiving a user-defined schedule of graph operations and a dataflow graph comprising a static schedule of the graph operations and a static schedule of communication operations; with the graph scheduler, generating a new schedule of the graph operations that is different than the static schedule of the graph operations based on the user-defined schedule of the graph operations and the static schedule of the graph operations; with the communication scheduler, receiving the dataflow graph and a user-defined schedule of the communication operations; with the communication scheduler, generating a new schedule of the communication operations that is different than the static schedule of the communication operations based on the user-defined schedule of the communication operations and the static schedule of the communication operations; with the runtime execution engine, receiving the dataflow graph, the new schedule of the graph operations, and the new schedule of the communication operations; with the runtime execution engine, configuring the array of reconfigurable units of the reconfigurable processor to execute the dataflow graph as defined in the new schedule of the graph operations and in the new schedule of the communication operations, and with the runtime execution engine, managing execution of the dataflow graph on the reconfigurable processor.

In Example 13, the method of Example 12 further comprises: with the graph scheduler, generating the new schedule of the graph operations by partitioning the graph operations into first graph operations that the runtime execution engine executes and second graph operations that the reconfigurable processor executes.

In Example 14, the method of Example 13 further comprises: with the runtime execution engine, executing a setup operation of the first graph operations before the reconfigurable processor starts to execute the second graph operations; and with the runtime execution engine, executing a tear-down operation of the first graph operations after the reconfigurable processor has finished to execute the second graph operations.

In Example 15, the method of Example 12 further comprises: with the graph scheduler, receiving an additional dataflow graph comprising an additional static schedule of additional graph operations; with the graph scheduler, receiving another user-defined schedule of the graph operations and the additional graph operations; and with the graph scheduler, generate another new schedule of the graph operations and the additional graph operations based on the static schedule of the graph operations, the additional static schedule of the additional graph operations, and the other user-defined schedule of the graph operations and the additional graph operations, wherein the other new schedule of the graph operations and the additional graph operations links the graph operations from the dataflow graph with the additional graph operations from the additional dataflow graph.

In Example 16, the method of Example 12, wherein the system further comprises a communication interface device that is coupled to the runtime execution engine and to the reconfigurable processor, and wherein the communication operations comprise at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

In Example 17, the method of Example 16 further comprises: with the communication scheduler, programming the new schedule of the communication operations in the communication interface device by setting up signal and wait communication operations in the communication interface device.

In Example 18, generating the new schedule of the communication operations of Example 16 further comprises: with the communication scheduler, parallelizing independent communication operations based on the user-defined schedule of the communication operations.

In Example 19, the method of Example 16, further comprises: with the communication scheduler, pipelining first and second communication operations of the communication operations into first and second communication sub-operations, wherein each communication sub-operation of the second communication sub-operations is dependent on a completion of a corresponding communication sub-operation of the first communication sub-operations; and generating the new schedule of the communication operations by scheduling each communication sub-operation of the second communication sub-operations after the corresponding communication sub-operation of the first communication sub-operations.

Example 20 is a non-transitory computer-readable storage medium including instructions that, when executed by a processing unit, cause the processing unit to operate a system that comprises a runtime execution engine, a graph scheduler, a communication scheduler, and a reconfigurable processor comprising an array of reconfigurable units, the instructions comprising: receiving a user-defined schedule of graph operations, a user-defined schedule of communication operations, and a dataflow graph comprising a static schedule of the graph operations and a static schedule of the communication operations; generating a new schedule of the graph operations that is different than the static schedule of the graph operations based on the user-defined schedule of the graph operations and the static schedule of the graph operations; generating a new schedule of the communication operations that is different than the static schedule of the communication operations based on the user-defined schedule of the communication operations and the static schedule of the communication operations; configuring the array of reconfigurable units of the reconfigurable processor to execute the dataflow graph as defined in the new schedule of the graph operations and in the new schedule of the communication operations; and managing execution of the dataflow graph on the reconfigurable processor.

What is claimed is:

1. A system comprising:
a reconfigurable processor comprising an array of reconfigurable units;
a graph scheduler configured to:
receive a dataflow graph comprising a static schedule of graph operations and a static schedule of communication operations from a compiler,
receive a user-defined schedule of the graph operations, and
generate a new schedule of the graph operations that is different than the static schedule of the graph operations based on the user-defined schedule of the graph operations and the static schedule of the graph operations;
a communication scheduler configured to:
receive the dataflow graph from the compiler,
receive a user-defined schedule of the communication operations, and
generate a new schedule of the communication operations that is different than the static schedule of the communication operations based on the user-defined schedule of the communication operations and the static schedule of the communication operations; and
a runtime execution engine configured to:
receive the dataflow graph, the new schedule of the graph operations, and the new schedule of the communication operations,
configure the array of reconfigurable units of the reconfigurable processor to execute the dataflow graph as defined in the new schedule of the graph operations and in the new schedule of the communication operations, and
manage execution of the dataflow graph on the reconfigurable processor.

2. The system of claim 1, further comprising:
a programming interface that transmits the user-defined schedule of the graph operations to the graph scheduler and the user-defined schedule of the communications operations to the communication scheduler.

3. The system of claim 1, further comprising:
an intelligent graph orchestrator and execution engine that is configured to:
receive the dataflow graph and the new schedule of the graph operations;
receive linker parameters and mutable parameters; and
schedule instructions within the graph operations using the linker parameters and the mutable parameters.

4. The system of claim 1, wherein the graph scheduler, based on the user-defined schedule of the graph operations, is further configured to generate the new schedule of the graph operations by partitioning the graph operations into first graph operations that the runtime execution engine executes and second graph operations that the reconfigurable processor executes.

5. The system of claim 4, wherein the runtime execution engine is further configured to:
execute a setup operation of the first graph operations before the reconfigurable processor starts to execute the second graph operations; and
execute a tear-down operation of the first graph operations after the reconfigurable processor has finished to execute the second graph operations.

6. The system of claim 1, wherein the graph scheduler is further configured to:
receive an additional dataflow graph comprising an additional static schedule of additional graph operations from a compiler;
receive another user-defined schedule of the graph operations and the additional graph operations; and
generate another new schedule of the graph operations and the additional graph operations based on the static schedule of the graph operations, the additional static schedule of the additional graph operations, and the other user-defined schedule of the graph operations and the additional graph operations, wherein the other new schedule of the graph operations and the additional graph operations links the graph operations from the dataflow graph with the additional graph operations from the additional dataflow graph.

7. The system of claim 1, further comprising:
a communication interface device that is coupled to the runtime execution engine and to the reconfigurable processor, and wherein the communication operations comprise at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

8. The system of claim 7, wherein the communication scheduler is further configured to program the new schedule of the communication operations in the communication interface device.

9. The system of claim 8, wherein the communication scheduler, for programming the new schedule of the communication operations in the communication interface device, is further configured to set up signal and wait communication operations in the communication interface device.

10. The system of claim 7, wherein the communication scheduler is further configured to generate the new schedule of the communication operations by parallelizing independent communication operations based on the user-defined schedule of the communication operations.

11. The system of claim 7, wherein the communication scheduler is further configured to:
pipeline first and second communication operations of the communication operations into first and second communication sub-operations, wherein each communication sub-operation of the second communication sub-operations is dependent on a completion of a corresponding communication sub-operation of the first communication sub-operations; and
generate the new schedule of the communication operations by scheduling each communication sub-operation of the second communication sub-operations after the corresponding communication sub-operation of the first communication sub-operations.

12. A method of operating a system that comprises a runtime execution engine, a graph scheduler, a communication scheduler, and a reconfigurable processor comprising an array of reconfigurable units, the method comprising:
with the graph scheduler, receiving a user-defined schedule of graph operations and a dataflow graph comprising a static schedule of the graph operations and a static schedule of communication operations;
with the graph scheduler, generating a new schedule of the graph operations that is different than the static schedule of the graph operations based on the user-defined schedule of the graph operations and the static schedule of the graph operations;
with the communication scheduler, receiving the dataflow graph and a user-defined schedule of the communication operations;
with the communication scheduler, generating a new schedule of the communication operations that is different than the static schedule of the communication operations based on the user-defined schedule of the communication operations and the static schedule of the communication operations;
with the runtime execution engine, receiving the dataflow graph, the new schedule of the graph operations, and the new schedule of the communication operations;
with the runtime execution engine, configuring the array of reconfigurable units of the reconfigurable processor to execute the dataflow graph as defined in the new schedule of the graph operations and in the new schedule of the communication operations, and with the runtime execution engine, managing execution of the dataflow graph on the reconfigurable processor.

13. The method of claim 12, further comprising:
with the graph scheduler, generating the new schedule of the graph operations by partitioning the graph operations into first graph operations that the runtime execution engine executes and second graph operations that the reconfigurable processor executes.

14. The method of claim 13, further comprising:
with the runtime execution engine, executing a setup operation of the first graph operations before the reconfigurable processor starts to execute the second graph operations; and
with the runtime execution engine, executing a tear-down operation of the first graph operations after the reconfigurable processor has finished to execute the second graph operations.

15. The method of claim 12, further comprising:
with the graph scheduler, receiving an additional dataflow graph comprising an additional static schedule of additional graph operations;
with the graph scheduler, receiving another user-defined schedule of the graph operations and the additional graph operations; and
with the graph scheduler, generate another new schedule of the graph operations and the additional graph operations based on the static schedule of the graph operations, the additional static schedule of the additional graph operations, and the other user-defined schedule of the graph operations and the additional graph operations, wherein the other new schedule of the graph operations and the additional graph operations links the graph operations from the dataflow graph with the additional graph operations from the additional dataflow graph.

16. The method of claim 12, wherein the system further comprises a communication interface device that is coupled to the runtime execution engine and to the reconfigurable processor, and wherein the communication operations comprise at least one of a communication operation between two reconfigurable units of the array of reconfigurable units, a communication operation between the runtime execution engine and a reconfigurable unit of the array of reconfigurable units, a communication operation between the runtime execution engine and the communication interface device, or a communication operation between a reconfigurable unit of the array of reconfigurable units and the communication interface device.

17. The method of claim 16, further comprising:
with the communication scheduler, programming the new schedule of the communication operations in the communication interface device by setting up signal and wait communication operations in the communication interface device.

18. The method of claim 16, wherein generating the new schedule of the communication operations further comprises:
with the communication scheduler, parallelizing independent communication operations based on the user-defined schedule of the communication operations.

19. The method of claim 16, further comprising:
with the communication scheduler, pipelining first and second communication operations of the communication operations into first and second communication sub-operations, wherein each communication sub-operation of the second communication sub-operations is dependent on a completion of a corresponding communication sub-operation of the first communication sub-operations; and
generating the new schedule of the communication operations by scheduling each communication sub-operation of the second communication sub-operations after the corresponding communication sub-operation of the first communication sub-operations.

20. A non-transitory computer-readable storage medium including instructions that, when executed by a processing unit, cause the processing unit to operate a system that comprises a runtime execution engine, a graph scheduler, a communication scheduler, and a reconfigurable processor comprising an array of reconfigurable units, the instructions comprising:
receiving a user-defined schedule of graph operations, a user-defined schedule of communication operations, and a dataflow graph comprising a static schedule of the graph operations and a static schedule of the communication operations;
generating a new schedule of the graph operations that is different than the static schedule of the graph operations based on the user-defined schedule of the graph operations and the static schedule of the graph operations;
generating a new schedule of the communication operations that is different than the static schedule of the communication operations based on the user-defined schedule of the communication operations and the static schedule of the communication operations;
configuring the array of reconfigurable units of the reconfigurable processor to execute the dataflow graph as defined in the new schedule of the graph operations and in the new schedule of the communication operations; and
managing execution of the dataflow graph on the reconfigurable processor.
